(19) United States
(12) Patent Application Publication
(10) Pub. No.: US 2026/0355664 A1
(43) Pub. Date: Nov. 12, 2026

(54) Framed Air Filters, Frames for Air Filters, And Kits for Framed Air Filters

(71) Applicant: 3M INNOVATIVE PROPERTIES COMPANY, St. Paul, MN (US)

(72) Inventors: Mark A. Sanocki, Vadnais Heights, MN (US); Alonso M. Hernandez, Minneapolis, MN (US); Glen O. Gregerson, Hudson, WI (US); Bryan L. Gerhardt, Woodbury, MN (US); Craig D. Thompson, Inver Grove Heights, MN (US)

(21) Appl. No.: 19/122,859

(22) PCT Filed: Nov. 3, 2023
(86) PCT No.: PCT/IB2023/061115

§ 371 Date: Apr. 21, 2025

Related U.S. Application Data
(60) Provisional application No. 63/426,447, filed on Nov. 18, 2022.
(60) Provisional application No. 63/452,484, filed on Mar. 16, 2023.

(51) Int. Cl. B01D 46/00; B01D 46/10; B01D 46/52

(52) U.S. Cl. CPC B01D 46/0005; B01D 46/10; B01D 46/521; B01D 2265/028; B01D 2265/06

(57) ABSTRACT

Rectangular perimeter frames for air filters, framed air filters, and kits for making perimeter frames and framed air filters. Such a frame may include first and second opposing primary frame portions that respectively comprise first and second upstream-open-ended elongate slots that are configured to receive first and second reinforced edge panels of a rectangular, pleated air filter media.

### BACKGROUND

Air filters are commonly used in powered air-handling apparatus, e.g. residential and commercial heating and air-conditioning (HVAC) systems, room air purifiers, and so on, in order to remove dust and dirt particles and the like. Conventional air filters have permanent rigid frames that dictate that the air filter must exhibit its end-use size when shipped to a retailer, when presented to potential purchasers, and when stored by an end-user. Consequently, these air filters undesirably occupy a relatively large volume of space on transportation vehicles, on retailer shelves, and in end-user's homes.

### SUMMARY

Herein are disclosed perimeter frames for air filters, framed air filters, kits for making perimeter frames and framed air filters, and methods of installing pleated air filter media into perimeter frames. In one aspect, such a frame may include first and second opposing primary frame portions that respectively comprise first and second upstream-open-ended elongate slots that are configured to receive first and second reinforced edge panels of a rectangular, pleated air filter media. These and other aspects will be apparent from the detailed description below. In no event, however, should the above summaries be construed as limitations on the claimed subject matter, which subject matter is defined solely by the attached claims, as may be amended during prosecution.

### BRIEF DESCRIPTION OF THE DRAWINGS

FIG. 1 is a perspective view, generally from an upstream side, of an exemplary framed air filter as disclosed herein.

FIG. 2 is a perspective view of the air filter of FIG. 1, viewed generally from the downstream side.

FIG. 3 is a perspective view, generally from the upstream side, of the perimeter frame of the air filter of FIG. 1.

FIG. 4 is a perspective view, generally from the downstream side, of the perimeter frame of the air filter of FIG. 2.

FIG. 5 is an exploded view, generally from the upstream side, of the perimeter frame of FIG. 3.

FIG. 6 is a magnified isolated view of one corner of the exploded-view perimeter frame of FIG. 5.

FIG. 7 is a cross-sectional view of a primary frame portion, taken across line 7-7 as shown in FIG. 3.

FIG. 8 is a cross-sectional view of a secondary frame portion, taken across line 8-8 as shown in FIG. 3.

FIG. 9 is a perspective view, generally from a downstream side, of an exemplary pleatpack suitable for use in a framed air filter.

FIG. 10 is a cross-sectional view of a primary frame portion and of a primary edge of a pleated air filter media as installed in the primary frame portion.

FIG. 11 is a perspective view, generally from an upstream side, of another exemplary pleatpack suitable for use in a framed air filter.

FIG. 12 is a perspective view, generally from a downstream side, of a corner of an exemplary support structure comprising an exemplary perimeter frame and subassembly.

FIG. 13 is a side perspective view, generally from an upstream side, of a terminal end of an exemplary support member of an exemplary subassembly.

FIG. 14 is a perspective view, generally from a downstream side, of another exemplary support structure comprising a perimeter frame and a downstream support subassembly.

FIG. 15 is a perspective view, generally from an upstream side, of another exemplary support structure comprising a perimeter frame and a downstream support subassembly.

FIG. 16 is an exploded view of a main body and a cover of the exemplary support structure of FIG. 15.

FIG. 17 is a perspective view, generally from an upstream side, of another exemplary framed air filter as disclosed herein.

FIG. 18 is a perspective exploded view of the perimeter frame of FIG. 17.

FIG. 19 is a perspective view of a corner of a downstream part of the perimeter frame of FIG. 18.

FIG. 20 is a perspective view, generally from an upstream side, of portions of the pleated filter media of FIG. 17.

Like reference numbers in the various figures indicate like elements. Unless otherwise indicated, all figures and drawings in this document are not to scale and are chosen for the purpose of illustrating different embodiments of the invention. In particular the dimensions of the various components are depicted in illustrative terms only, and no relationship between the dimensions of the various components should be inferred from the drawings, unless so indicated.

Although terms such as “first” and “second” may be used in this disclosure, it will be understood that those terms are used in their relative sense only unless otherwise noted. As used herein as a modifier to a property, attribute or relationship, the term “generally”, unless otherwise specifically defined, means that the property, attribute or relationship would be readily recognizable by a person of ordinary skill but without requiring absolute precision or a perfect match (e.g., within +/−20% for quantifiable properties). The term “substantially” means to a high degree of approximation (e.g., within +/−10% for quantifiable properties) but again without requiring absolute precision or a perfect match. The term “configured to” and like terms is at least as restrictive as the term “adapted to”, and requires actual design intention to perform the specified function rather than mere capability of performing such a function.

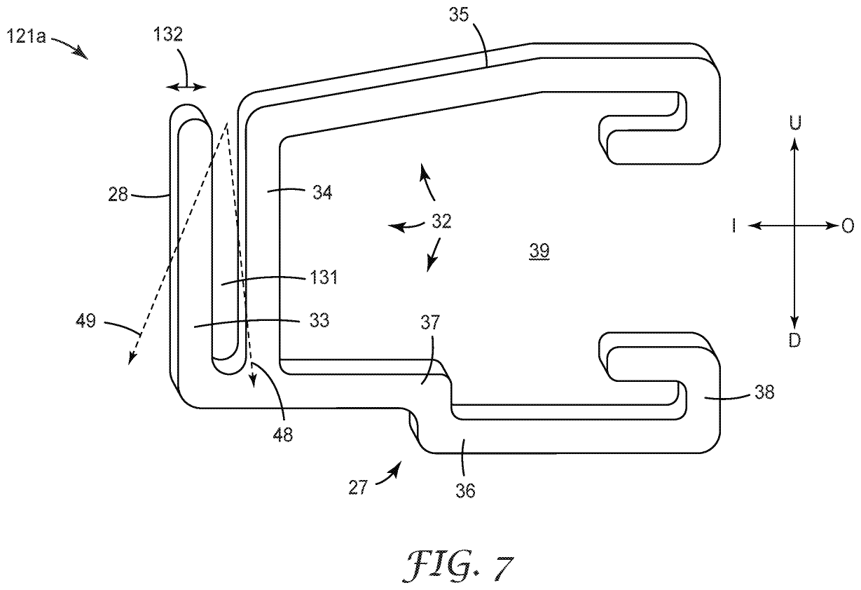

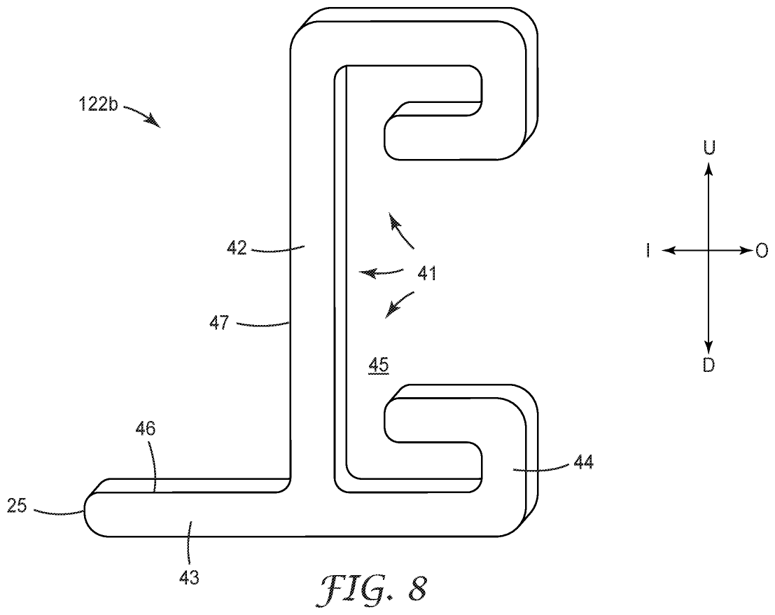

Terms such as “outer”, “outward”, “outwardmost”, “outwardly”, and the like, refer to a direction generally away from the geometric center of the air filter media and framed air filter. Terms such as “inner”, “inward”, “inwardmost”, “inwardly”, and the like, refer to a direction generally toward the geometric center. For reference, inward and outward directions I and O are indicated in FIGS. 7 and 8. The term “upstream” is used to denote a side of a framed air filter upon which, with the framed air filter installed in a powered air-handling apparatus, moving air will impinge on the framed air filter to be filtered thereby. The term “downstream” is used to denote the side of such an air filter from which filtered air will exit. Various Figures are marked with “U” and “D” to aid in recognition of upstream and downstream sides of the air filters and components thereof. These terms are used for convenience of description herein, in recognition of the observation that filters are often placed into powered air-handling apparatus with a particular side of the air filter facing the stream of incoming air (i.e., facing upstream) and with an opposing side of the filter facing downstream. However, it will be appreciated that in some cases an air filter might be e.g. symmetrical so that it can be placed in an airstream in either orientation; thus, it is emphasized that the terms upstream and downstream are used herein for convenience of description of various components of the filter and their geometric relationships.

The term “frame portion” is used to denote a portion of an assembled perimeter frame that is positioned on, and along, a particular edge of the filter media. The term “frame piece” is used to denote an item (e.g. a molded piece, a profile-extruded piece, or a thermoformed piece) that can be assembled with other frame pieces to collectively form an assembled frame. As will become clear from discussions later herein, a frame portion may include the entirety of a primary or secondary frame piece, along with e.g. portions of one or more corner frame pieces.

### DETAILED DESCRIPTION

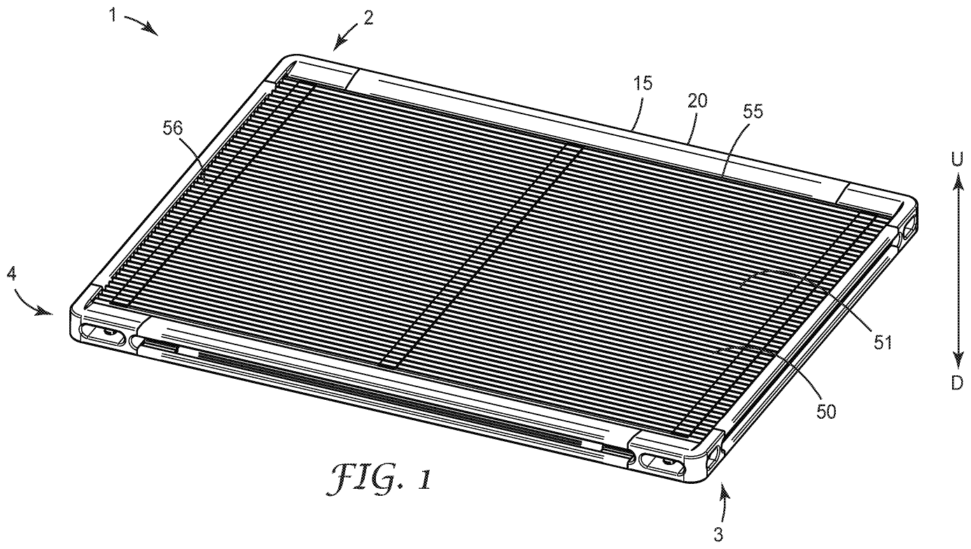

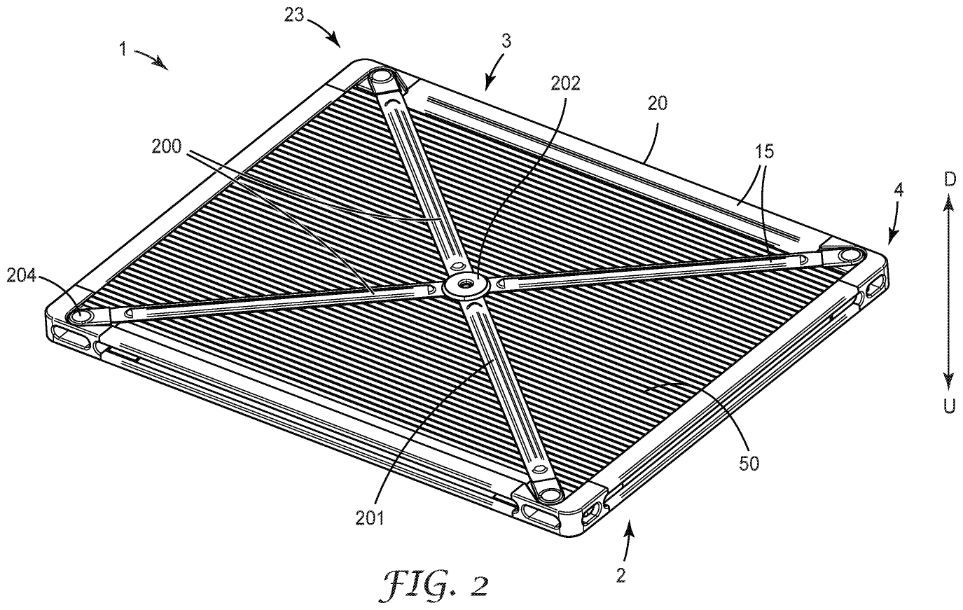

Shown in FIG. 1 in perspective view generally from the upstream side, and in FIG. 2 generally from the downstream side, is an exemplary framed air filter 1 as disclosed herein. Framed air filter 1 comprises an upstream side 2 and a downstream side 3 as defined and described above. Framed air filter 1 comprises pleated air filter media 51 (often, in the form of a “pleatpack” 50 as described later herein) and perimeter frame 20 positioned around perimeter 54 of filter media 51. Pleated air filter media 51, perimeter frame 20, and framed air filter 1, will all be at least generally rectangular in shape (which specifically includes square shapes), so that the framed air filter 1 comprises four corners 4.

For convenience in describing such generally rectangular geometry, the four major portions of frame 20 and frame pieces and components thereof may occasionally be referred to herein by a lettered subscript (e.g., a, b, c, or d). Not all corresponding features of the various frame portions are individually identified by number in the Figures, but will be understood to be present in many embodiments. Similarly, not all components or features will be individually subscripted to denote the particular frame portion or piece in which they are depicted in the various Figures, but it will be understood that all such subscripts can be applied as needed.

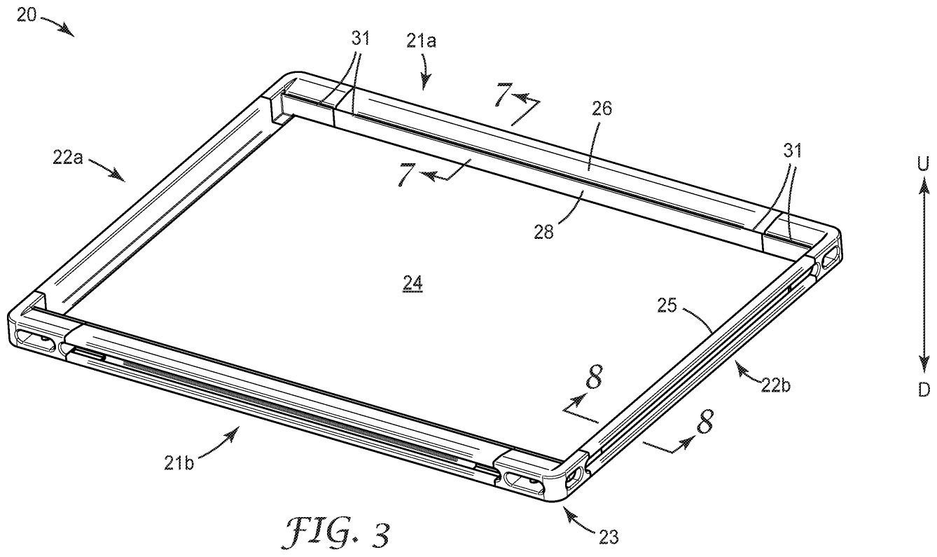

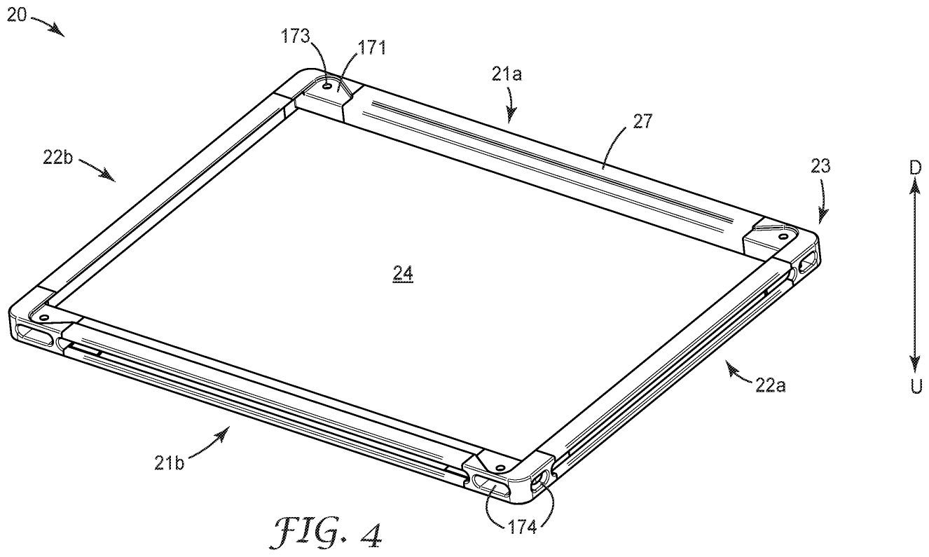

Frame 20 may thus take the form of a rectangular frame with four major elongate frame portions 21a, 21b, 22a, and 22b, as indicated in FIGS. 3 and 4, which are upstream and downstream views of an exemplary perimeter frame 20 in the absence of any filter media. Each such frame portion will be positioned on one of the four major edges of the filter media and with neighboring frame portions meeting to form four corners 23 of perimeter frame 20. In some embodiments, two types of frame portions may be present-opposing portions 21a and 21b, which will be termed “primary” frame portions, and opposing portions 22a and 22b, which will be termed “secondary” frame portions. In many embodiments, the opposing primary frame portions 21 may be identical to each other and the opposing secondary frame portions 22 may be identical to each other. The primary frame portions 21a and 21b will be positioned along primary edges of pleated air filter media 51, and the secondary frame portions 22a and 22b will be positioned along secondary edges of the pleated air filter media, as discussed in detail later herein. Each primary frame portion 21a and 21b will comprise an upstream-open-ended elongate slot 31 as indicated in FIG. 3. Pleated filter media 51 (e.g. as part of a pleatpack 50) can be installed into perimeter frame 20 by inserting first and second reinforced edge panels 57 of first and second primary edges of the pleated filter media, into first and second upstream-open-ended elongate slots 31 of first and second primary frame portions 21a and 21b, as described in detail later herein. In some embodiments, a perimeter frame 20 may be accompanied by a downstream support subassembly 200 (e.g. comprising multiple downstream support members 201) as illustrated in exemplary embodiment in FIG. 2; the combination of perimeter frame 20 and a downstream support subassembly 200 will be referred to herein as a support structure 15.

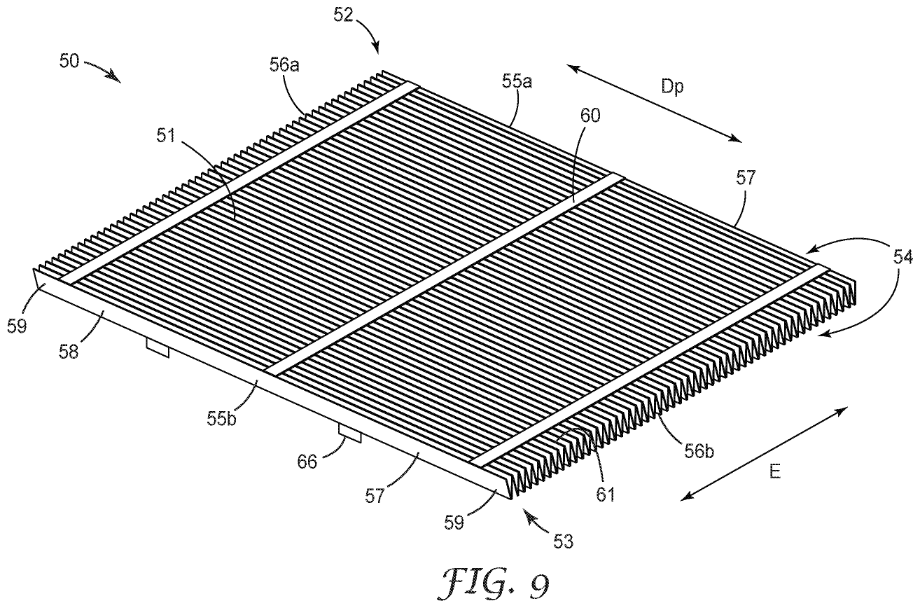

An air filter 1 as disclosed herein comprises an air filter media, e.g. a pleated filter media 51, as shown in exemplary embodiment in FIG. 9. By “pleated” is meant an air-filtration media (e.g. a fibrous web) that has been folded into rows of generally parallel, oppositely oriented folds that provide alternating peaks and valleys on both sides of the media. For example, and as shown in FIG. 9, the pleated filter media 51 includes a plurality of pleats 61 and comprises elongate upstream pleat tips and elongate downstream pleat tips. Such a pleated media will comprise an upstream face 53 and a downstream face 52 and will exhibit a pleat direction (Dₚ, indicated in FIG. 9) that is parallel to the long axes of the elongate pleat tips. Various parameters of the pleated media (e.g. pleat spacing, pleat height, and so on) can be chosen as desired; typically such parameters will be chosen for the pleated filter media in its expanded, end-use configuration as discussed below. The pleated structure allows the filter media to be “accordionized” into a collapsed configuration in which the pleat tips (and pleat panels) are crowded quite close together or even in contact with each other, and then expanded into the end-use configuration at the desired time. Thus, such a filter media may be provided (e.g. in a kit) in a collapsed configuration, and expanded into the end-use configuration by an end-user.

A pleated filter media 51 can thus be expanded at least once from a collapsed condition to an expanded, end-use condition (e.g. as depicted in FIG. 9, as well as in FIGS. 1 and 2). The expansion can be performed along an expansion direction E as indicated in FIG. 9; in many embodiments, the pleated media can only expand along this single direction. In some embodiments, the pleated media can be repeatedly transitioned back and forth between an expanded, end-use condition and a collapsed condition. However, in some embodiments the pleated filter media may only need to be expandable from a collapsed condition to an expanded, end-use condition (e.g., a condition in which the pleated filter media has a span that matches the dimension of a filter receptacle of a powered air-handling apparatus) a single time. That is, in some such embodiments, the pleated filter media may not need to be collapsible back to the original collapsed condition.

The pleated filter media 51 is configured to quickly and easily transition from a collapsed configuration to an expanded, end-use configuration. In some embodiments, a removable wrapper or other packaging can be provided to initially retain the air filter media in the collapsed state, and can be removed to allow expansion. The air filter media does not require a conventional, factory-installed rigid frame permanently surrounding the pleated filter media, and can advantageously be shipped, inventoried, displayed, and so on, in the collapsed state.

### Reinforced Edge Panels

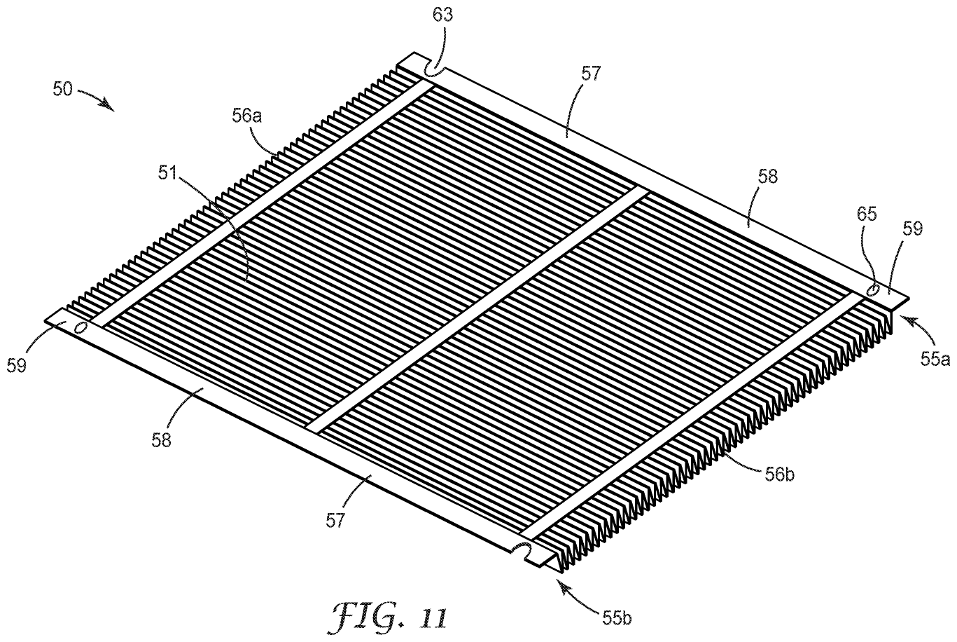

At least when expanded into an expanded configuration, a pleated filter media 51 can have a rectangular shape with a rectangular perimeter 54. The pleated filter media will comprise first and second opposing edges 55a and 55b, which will be termed “primary” opposing edges. Each primary edge will comprise a reinforced edge panel 57 (visible in FIG. 9, but more easily seen in FIG. 11 in which the reinforced edge panels 57 are rotated to an extended position). Reinforced edge panels 57 are configured to be inserted into the above-mentioned upstream-open-ended elongate slots 31 of the primary frame portions 21 of perimeter frame 20, in order to install filter media 51 into perimeter frame 20 to form a framed air filter 1. (The reinforced edge panels 57 may also provide convenient handles for holding pleated media 51 while it is handled, e.g. while it is being expanded and installed into a perimeter frame.)

A pleated filter media 51 will further comprise first and second opposing edges 56a and 56b, which will be termed “secondary” opposing edges. By definition, these secondary edges 56 are “corrugated edges” (that exhibit a zig-zag shape when viewed along the pleat direction Dₚ, as is evident from FIG. 9); the above-described primary opposing edges 55 are non-corrugated edges. In a framed air filter 1 as disclosed herein, these secondary, corrugated opposing edges will be closely abutted against (e.g. in contact with) an inward surface 47 of a secondary frame portion 22. Also, downstream pleat tips 62 of secondary edge sections of the pleated filter media 51 will be closely abutted against (e.g. in contact with) an upstream surface 46 of a downstream support flange 43 of a secondary frame portion 22, as discussed in detail later herein.

A pleated filter media 51 comprising reinforced edge panels 57 will be referred to herein as a “pleatpack” 50. In some embodiments, a pleatpack 50 may include other components in addition to the pleated filter media 51 and the reinforced edge panels 57. Thus in some embodiments, the pleatpack may include one or more entities 60 that are configured e.g. to limit the expansion of the pleated media to a desired end-use configuration (e.g. in which the pleated media exhibits a predetermined pleat spacing). In the exemplary illustrations of FIGS. 1 and 9, such entities 60 are in the form of elongate ribbons that are bonded to pleat tips of the pleated media. However, in various embodiments, any such entity or entities may take the form of a nonwoven scrim, a netting, a wire mesh, a set of filaments, and so on. In some embodiments any such entity may be bonded only to the pleat tips of the pleated media. In some embodiments, such entities may take the form of a set of extruded filaments of the general type described in U.S. Patent Application Publications 2021/0229022 and 2021/0229023, both of which are incorporated by reference in their entirety herein. In some embodiments, any such entities will be flexible (e.g. so that the entities can fold or gather to accommodate their excess length when the pleated media is collapsed); however, in some such embodiments, any such entities will be inelastic so as to limit the expansion to a desired amount that establishes a desired end-use pleat spacing. For example, such an entity could be in the form of one or more ribbons, strips, filaments, etc. that is attached to the pleat tips and that, when extended to its maximal length, provides a “dead-stop” at a desired span. Thus in some embodiments such an entity may be non-elastic, meaning that it exhibits an elongation at break of less than 5%. In other embodiments, any such entity may be elastic, e.g. so as to exhibit an elongation at break of at least 5, 20, 50, 100, or 200%.

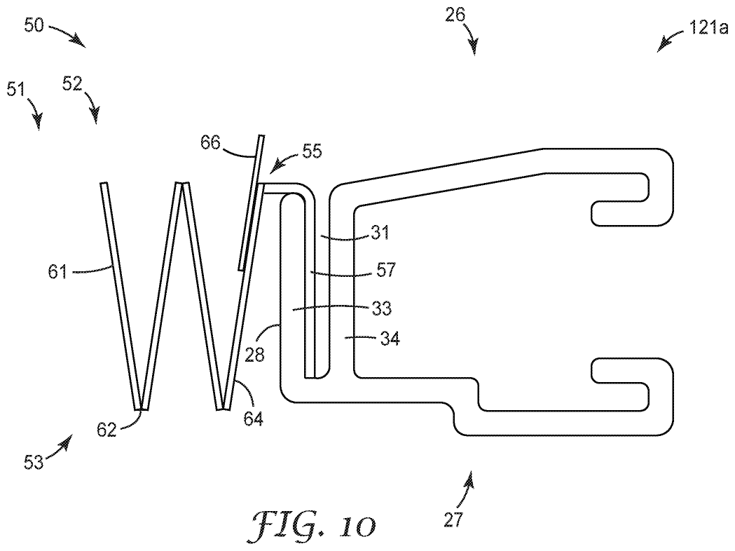

In various embodiments, any such entities 60 may be present on the upstream face 53 of the pleated air filter media 51 (as in the exemplary illustration of FIG. 9), on the downstream face 52 of the media (as in the exemplary illustration of FIG. 11), or on both. In some embodiments, it may be convenient that any such entities 60 are on the upstream side of the filter media (as in the exemplary illustration of FIG. 11), for ease of inserting a reinforced edge panel 57 of the filter media into an elongate slot 31 of a perimeter frame, as will be evident from discussions later herein. Thus in some particular embodiments, such entities 60 will be present on the upstream side of the filter media but not on the downstream side of the filter media. In some embodiments, if such entities 60 are present on the downstream side of the pleated filter media, they may terminate at (e.g. be attached to) a pleat panel 64 that is a nearest-neighbor pleat panel to the reinforced edge panel 57 (such a panel 64 is visible in FIG. 10, noting in passing that the downstream side of the framed air filter is the “lower” side as viewed in FIG. 10). That is, in such embodiments, the entities 60 may stop short of (and/or may not be attached to) the reinforced edge panel 57, so that the presence of entities 60 does not interfere with the ability to insert the reinforced edge panel into an elongate slot 31 of a perimeter frame 20.

The pleated air filter media 51 may be of any suitable type and composition. The air filter media is typically sheet-like, with (with the media in an expanded condition) a span along the expansion direction E, and a width along the pleat direction Dₚ, that are considerably greater than the thickness of the air filter media. In some embodiments, filter media may be, or include, a nonwoven material. In some embodiments, filter media may comprise fiberglass fibers. Nonwoven webs which may be used as, or as a layer, of, the filter media can be a high loft spunbond web, such as described, for example, in U.S. Pat. No. 8,162,153. In some embodiments, the filter media can be, or include, a low loft spunbond web, such as those described in U.S. Pat. No. 7,947,142. In some embodiments, an electrostatic charge is optionally imparted into or on to material(s) of the filter media. Thus, the filter media can be an electret nonwoven web. Electric charge can be imparted to the filter media in a variety of ways as is well known in the art, for example by hydrocharging, corona charging, etc. (e.g. as described in U.S. Pat. No. 7,947,142). In other embodiments, the filter media is not electrostatically charged. Pleats can be formed in the filter media using various methods and components as are well known in the art, for example those described in U.S. Pat. Nos. 6,740,137 and 7,622,063.

The primary edges 55 of a pleated filter media 51 may be equipped with reinforced edge panels 57 in any suitable way. In some embodiments, such an edge panel may be provided by one or more end pleat-panels of the filter media itself. Such a reinforced edge panel will be referred to herein as being “integral” with the filter media. For example, an end pleat-panel of the filter media may be impregnated with a liquid resin that, after hardening, will render the end pleat-panel stiff and rigid. Another method is to bond or otherwise attach several panels at the end of the pleated media to each other to form a single, thickened and stiffened end panel that serves as a reinforced edge panel. Such an arrangement may be achieved e.g. by ultrasonically bonding two or more panels together; or, in general, by subjecting two or more such panels to heat and pressure to melt-bond the panels together into a singled, thickened and stiffened end panel. Another variation is to gather two or more end panels of the pleated media together and to co-impregnate them with a hardenable liquid to form a thick and stiff layer. Still another variation is to gather two or more end panels together and mechanically fasten them together e.g. with staples.

In other approaches, a reinforced edge panel may be an entity that is separately made and is then attached to an end of the pleated filter media. Such a reinforced edge panel will be referred to as being non-integral with the pleated filter media. Methods for providing a non-integral reinforced edge panel include bonding, e.g. adhesively bonding, a suitably sized and shaped piece of chipboard or a stiff and robust nonwoven, or a layer of any other suitable material, to an end panel of the pleated media.

However made (and whether integral or non-integral with the filter media), a reinforced edge panel 57 will typically be elongate with a long axis that is aligned with the pleat direction Dₚ, as is evident e.g. from FIGS. 9 and 11. Such a reinforced edge panel 57 will be permanently attached to the filter media (e.g. to a nearest-neighbor pleat panel 64 of a pleated media in the general manner depicted in FIG. 9), at least at a trailing end of the reinforced edge panel (in this context, “permanently attached” encompasses an edge panel that is integral with the filter media). The reinforced edge panel 57 will have an opposing, leading end that can be oriented generally downstream so that it can be inserted into an upstream-open-ended elongate slot of a perimeter frame as discussed in detail elsewhere herein.

Although depicted in FIG. 9 as being continuous along its entire elongate length, in general a reinforced edge panel 57 of a pleated air filter media does not necessarily have to be continuous in the manner shown in FIG. 9. Rather, in some embodiments a reinforced edge panel may be e.g. interrupted at one or more locations along its elongate length. Similarly, although in many embodiments a reinforced edge panel 57 may extend along the entire “width” (along the pleat direction) of the pleated media, in some embodiments an edge panel 57 may be a different length, e.g. may be somewhat shorter or longer. In some embodiments, an edge panel 57 may comprise other features such as mating features 63 and/or 65, as depicted in FIG. 11 and as discussed in detail later herein.

In some embodiments, a pleated air filter media may comprise one or more removal tabs 66 at the first and second primary ends of the pleated air filter media, as shown in exemplary embodiment in FIG. 9 (in FIG, 9, the removal tabs 66 are visible at the first primary end 55a but, in the viewing perspective of FIG. 9, are not visible at the second primary end 55b). Such removal tabs 66 may be configured to be grasped by an end-user and pulled in a generally upstream manner to initiate and/or assist the removing of a reinforced edge panel 57 of the filter media from an upstream-open-ended elongate slot of a perimeter frame. Accordingly, in some embodiments any such removal tab(s) will be on the upstream side of the filter media. Such a removal tab 66 may be e.g. attached (via any suitable arrangement) to one or more pleat panels that are close to the primary end of the filter media, and/or may protrude generally upstream, as depicted in the exemplary arrangement of FIG. 10. Typically, any such tab will not extend along the entire width of the filter media in the pleat direction (as is apparent from FIG. 9); all that is needed is that one or more tabs be provided that are of sufficient size to be easily grasped.

In some embodiments, a perimeter frame 20 as disclosed herein may be assembled by an end-user from component pieces. For example, in some embodiments the component pieces may be provided to an end-user as a kit, with the end-user connecting the component pieces to each other to form the perimeter frame. A pleated filter media can then be installed into the thus-formed perimeter frame. By definition, a “kit” as disclosed herein is a set of component pieces that is provided to an end-user, e.g. along with instructions for assembling various components of the kit into a perimeter frame. Such instructions may be e.g. printed and may physically accompany the kit; or, the instructions may be virtual with the end-user being e.g. directed to a website to access the instructions. By definition, a “kit” as disclosed herein will not encompass any set of component pieces that are described as being assembled by the supplier (e.g. at the production facility at which the component pieces are made) rather than being provided to an end-user for assembly. In other words, a kit as disclosed herein will not encompass a set of component pieces merely because the component pieces are depicted in an intermediate, e.g. unassembled or partially-assembled, state in a factory. Rather, in order to be a kit, the component pieces must be purposefully configured to be provided to an end-user in an unassembled state for assembly by the end-user.

It is emphasized however that a perimeter frame may not necessarily be assembled from a kit of e.g. three, four, five, or more component pieces; rather, in some cases a perimeter frame may already be in final form (e.g. in a two-part form, or as a clamshell, both as discussed in further detail later herein) when provided to an end user. It is thus emphasized that descriptions and characterizations of user-assembled, kit-derived perimeter frames herein are only applicable to such frames and do not require that all of the concepts disclosed herein must necessarily be used only with user-assembled, kit-derived perimeter frames.

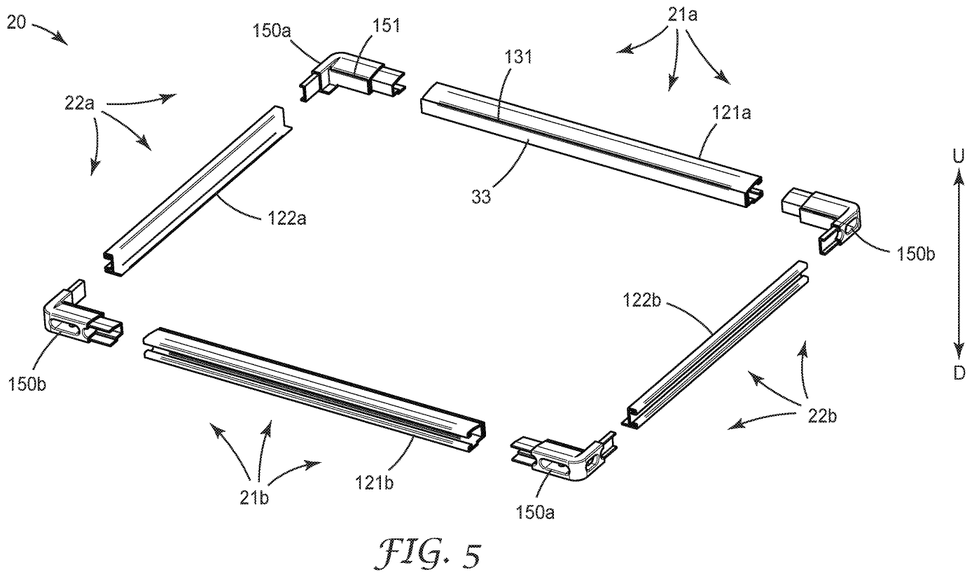

In some embodiments, a perimeter frame 20 of the general type shown in FIG. 3 may be assembled from a set (a “kit”) of component pieces of the general type shown in FIG. 5. (FIG. 5 is thus not merely an exploded view of various portions of frame 20 of FIG. 3; rather, it is also a view of a set of component pieces (e.g., a kit) from which such a frame can be assembled by an end-user.) In the depicted embodiment, the kit includes first and second opposing primary frame pieces 121a and 121b and first and second opposing secondary frame pieces 122a and 122b. Strictly speaking, such pieces will not become “opposing” until the frame is actually assembled; however, for convenience of description, these and other characterizations (e.g. in terms of a frame piece having an inward face, an upstream-open-ended elongate slot, etc.) will be applied to the frame pieces, for which their meaning will be readily apparent. Similarly, it will be apparent that some of the herein-described features of frame portions will be derived from features of frame pieces; some such features may be referred to by identical reference numerals whether they are being described as part of a frame piece or as part of a frame portion.

A kit of component pieces may further include corner frame pieces 150 as seen in FIG. 5; each such corner frame piece 150 may have a primary frame piece 121 and a secondary frame piece 122 connected thereto, with the primary and secondary frame pieces and the four corner frame pieces collectively forming the perimeter frame 20. Thus, as evident e.g. from comparison of FIGS. 3 and 5, a primary frame portion 21 that extends along a primary edge 55 of pleated filter media 51, may include a primary frame piece 121 in combination with sections of two corner frame pieces 150. For example, the primary frame portion of FIG. 5 that is labeled 21a, can include the entirety of primary frame piece 121a along with sections of the two neighboring corner frame pieces 150a and 150b. Similarly, a secondary frame portion 22 that extends a long a secondary edge 56 of pleated filter media 51, may include a secondary frame piece 122 in combination with sections of two corner frame pieces 150.

In some embodiments, such corner frame pieces 150 may include a first pair of such pieces that are generally or substantially identical to each other and a second pair of pieces that are identical to each other but, as made, are mirror-images of the first pair of pieces. Thus, the exemplary illustration of FIG. 5 depicts a first pair of identical corner frame pieces 150a, and a second pair of identical corner frame pieces 150b, with pieces 150b being mirror images of pieces 150a.

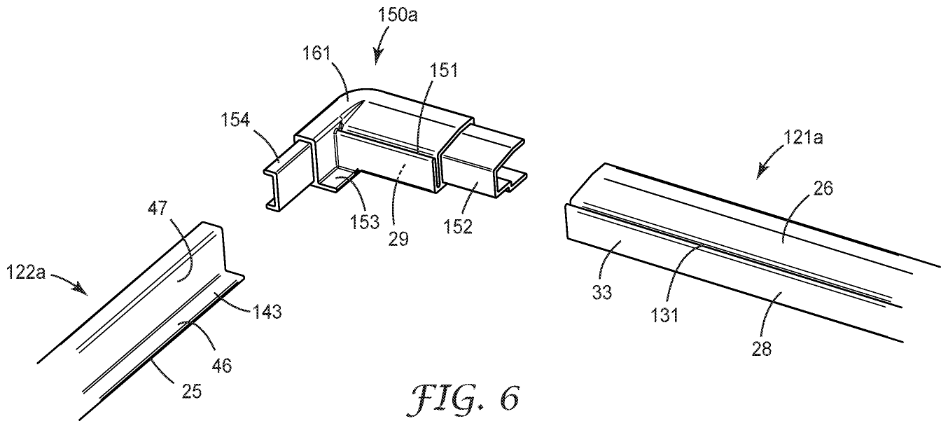

A corner frame piece 150 and a primary (or secondary) frame piece may be connected to each other in any suitable manner. In some embodiments, the connection may be disconnectable. However, in some embodiments, once a perimeter frame 20 is constructed it may never need to be disassembled; thus, in some embodiments the pieces may be connected in a non-disconnectable manner. In some embodiments, connections between the pieces may be purely mechanical, e.g. friction-fit connections of the general type illustrated in FIG. 5 (and as more easily visible in FIG. 6, which is a magnified view of one corner of the exploded frame of FIG. 5). In the depicted embodiment, corner frame pieces 150 each comprise male fittings 152 and 154 that can be slidably inserted into open ends of primary and secondary frame pieces 121 and 122. Any suitable combination of fittings may be used. For example, a corner frame piece may have one male fitting and one female fitting with the primary and/or secondary frame pieces being designed in concert. However, later discussions herein will reveal that in some embodiments it will be advantageous that primary and secondary frame pieces 121 and 122 will be uniform along their elongate length. Such a property requires that the open ends of the primary and secondary frame pieces will be identical to the remaining sections of the frame pieces and is conducive to an arrangement in which the corner frame pieces have male fittings that can be inserted into these open ends.

As disclosed herein, a pleated filtration media 51 may be installed into a perimeter frame 20 by inserting the leading ends of first and second reinforced edge panels 57 of primary (non-corrugated) edges 55 of the pleated filtration media into first and second elongate, upstream-open-ended slots 31 of first and second primary frame portions 21 of the frame 20 so that the first and second reinforced edge panels 57 are seated in the slots 31. Such an arrangement is depicted in exemplary illustration in FIG. 10, which is a cross-sectional view showing a reinforced edge panel 57 as received into a slot 31 in this manner. FIG. 7 depicts a similar cross-sectional view of a primary frame portion 21 in the absence of the pleated filtration media, and provides further details of features that may facilitate such an arrangement.

When a reinforced edge panel 57 is “seated” (or equivalently, “received”) in a slot 31, any suitable portion of the edge panel 57 may reside within the slot. In various embodiments, the proportion of the total area of the reinforced edge panel that is positioned within the slot may be e.g. 50%, 60%, 70%, 80%, 90%, or 95%. By way of a specific example, FIG. 10 shows an exemplary arrangement in which approximately 80% of the total area of reinforced edge panel 57 is seated in slot 31 (noting also that while FIG. 10 shows an upstream portion of reinforced edge panel 57 as being curved to allow the edge panel to be seated into the slot, this may not always be the case; in some embodiments the edge panel may remain at least generally planar). In some embodiments a reinforced edge panel 57 may have a protruding section (as discussed in detail later herein) that is specifically configured to not reside within the slot when the edge panel is seated in the slot.

As depicted in FIG. 10, the receiving of reinforced edge panels 57 of opposing primary (non-corrugated) edges 55 of a pleated filtration media 51 into elongate, upstream-open-ended slots 31 of opposing primary frame portions 21 of a frame 20 can allow the pleated filtration media 51 to be held in place on the frame, in spite of any force that is exerted on the filtration media by the impinging of flowing air on the upstream surface of the filter media. In at least some embodiments, this can be achieved without having to use any additional attachment methods such as e.g. adhesively bonding the reinforced edge panels to the frame (or, in general, adhesively bonding any portion of the filter media to any portion of the frame). In particular, in some embodiments the pleated filtration media may be held in place without having to pinch any portion of the pleated filtration media (or of a reinforced edge panel) between portions of the frame. That is, with the arrangements disclosed herein, the force of the impinging air on the upstream side of the filter media can have the effect of holding the filter media in place securely, so that at least in some embodiments, no additional measures are required.

To facilitate such arrangements, the elongate, upstream-open-ended slots 31 can be oriented appropriately; this orientation can be characterized in terms of a “depth” axis of such a slot 31. A depth axis of a slot 31 is an axis that extends along the slot from its upstream, open end toward its downstream, closed end. In FIGS. 7 and 10, the depicted slot 31 exhibits a depth axis of slot 31 that is essentially exactly aligned with the upstream-downstream axis of the filter and frame; however, this is not strictly necessary. Rather, in various embodiments, a slot 31 can comprise a depth axis that is oriented at least generally even with, or at an angle that is more positive than, the upstream-downstream axis of the air filter and frame. By a depth axis having a positive angle relative to the upstream-downstream axis is meant that the downstream end of the slot is positioned at least somewhat inwardly relative to the open, upstream end of the slot. Thus for example, arrow 49 of FIG. 7 depicts an exemplary arrangement in which the depth axis of slot 31 could be positioned at a positive angle of approximately 25 degrees relative to the upstream-downstream axis. A slot 31 may be oriented at any suitable positive angle as long as it still allows the reinforced edge panel to be inserted into the slot.

The above condition that a depth axis may be oriented at least generally even with the upstream-downstream axis allows for arrangements in which the depth axis is oriented at an angle that is slightly negative with respect to the upstream-downstream axis. Thus for example, arrow 48 of FIG. 7 depicts an exemplary arrangement in which the depth axis of slot 31 could be positioned at a negative angle of approximately 5 degrees relative to the upstream-downstream axis. It will be appreciated that a negative angle that is too large should not be used, because it might increase the likelihood of the reinforced edge panel of the pleated filter media being dislodged from the slot e.g. due to force exerted by impinging air.

In various embodiments, a slot 31 may exhibit a depth axis that is oriented at a positive angle that is at least 5, 10, 20, or 30 degrees. In further embodiments, a slot 31 may exhibit a depth axis that is oriented at a positive angle that is at most 65, 55, 45, 35, 25, 15, or 5 degrees. In various embodiments, a slot 31 may exhibit a depth axis that is oriented at a negative angle that is at most 20, 15, 10, or 5 degrees. In some embodiments a slot 31 may exhibit a depth axis that is within plus or minus 10, 5, or 2 degrees of the upstream-downstream axis of the air filter and frame. In some embodiments, a slot 31 (more specifically, the surfaces of walls 33 and 34 that define slot 31) may comprise features that enhance the retaining of a reinforced edge panel of a pleated filter media in the slot. Such features may take the form of e.g. appropriately oriented barbs, teeth, or the like.

The above discussions illustrate how an elongate, upstream-open-ended slot 31 of a primary frame portion 21 can receive a reinforced edge panel 57 of a pleated filter media 51 in order to install the pleated filter media into a perimeter frame 20. In embodiments in which a perimeter frame 20 is assembled from a kit of multiple pieces e.g. by an end user, at least some of the multiple component pieces can act in combination to provide such a slot 31. For example, FIG. 5, and in particular the magnified view of a frame corner shown in FIG. 6, reveals how, in some embodiments, an elongate, upstream-open-ended slot of a primary frame portion 21 may be provided by elongate, upstream-open-ended slots of multiple frame pieces, acting in combination. Specifically, FIG. 6 illustrates an arrangement in which primary frame piece 121a comprises an elongate, upstream-open-ended slot 131. Corner frame piece 150a likewise comprises an elongate, upstream-open-ended slot 151. When corner frame piece 150a and primary frame piece 121a are connected together, slot 151 of corner frame piece 150a will become a congruent extension of slot 131 of primary frame piece 121a. By this is meant that slot 151 is exactly parallel to, and is end-to-end aligned with, slot 131. Slots 131 and 151 of frame pieces 121a and 150a will thus become portions of the above-described elongate, upstream-open-ended slot 31 of primary frame portion 21a. Although not visible in FIG. 6, in many embodiments a slot 31 of a primary frame portion 21 may similarly include a slot in another corner frame piece at the opposing end of the primary frame portion. The slots in the corner frame pieces and the slot in the primary frame portion will be congruent so as to collectively provide the overall slot 31 of the primary frame portion, as evident from inspection of FIG. 3.

Thus, with reference to FIGS. 9 and 11, a reinforced edge panel 57 of a pleated air filter media 51 may comprise a major section (e.g. the section generally indicated by reference number 58 in FIGS. 9 and 11) that will be received into an elongate slot 131 of a primary frame piece 121, and one or more minor sections (e.g. the sections generally indicated by reference number 59 in FIGS. 9 and 11) that will be received into elongate slots 151 of corner frame pieces 150.

Another feature is visible in FIG. 5 and is more easily seen in FIG. 6. The corner frame piece 150a as depicted in FIG. 6 includes a short downstream support flange segment 153. When corner frame piece 150a is connected to secondary frame piece 122a, the end of downstream support flange segment 153 of corner frame piece 150a will closely abut the end of downstream support flange 143 of secondary frame piece 122a, so that segment 153 and flange 143 combine to collectively provide the previously-described downstream support flange 43 of secondary frame portion 22 of perimeter frame 20. Although not visible in FIG. 6, in many embodiments such a downstream support flange 43 of a secondary frame portion may include a downstream support flange segment in another corner frame piece at the other end of the secondary frame portion, so that the downstream support flange 143 of the secondary frame portion combines with the downstream support flange segments of the corner frame pieces to provide the downstream support flange 43 of the secondary frame portion.

When a pleated filter media 51 is installed into perimeter frame 20, the downstream support flange 43 of a secondary frame portion (produced e.g. as described above) of the frame will underlie (in a downstream direction) the secondary (corrugated) edges 56 of the pleated filter media 51. In such a case, at least some (but not necessarily all) of the downstream pleat tips 62 along this secondary edge 56 of the pleated media may be in contact with the upstream face 46 of downstream support flange 43. Also, in some embodiments at least some portions of the outward, corrugated (secondary) edges 56 of pleated filter media 51 may closely abut (e.g. within 1.0, 0.5, or 0.2 mm) the inward surface 47 of main wall 42 of secondary frame portion 22. In some embodiments, at least some portions of these corrugated edges 56 may be in contact with some portions of inward surface 47. (Any of these conditions may occur for a section of secondary frame portion 22 that is provided by a secondary frame piece 122, and/or may occur for a section of secondary frame portion 22 that is provided by a part of a corner frame piece 150.)

In some embodiments a resilient gasketing material (e.g. a strip of resilient foam or fibrous material, e.g. with an adhesive backing so as to attach the strip to inward surface 47) may be attached to inward surface 47 to minimize any air leakage around the corrugated edges of the air filter media. However, in most instances this has not been found to be necessary; thus, in some embodiments, no such gasketing or space-filling material (whether as an adhesive-backed strip or of any other construction) will be present along surface 47.

As evident from the cross-sectional view of FIGS. 7 and 10, in some embodiments a primary frame piece 121 may comprise a shape, when viewed in cross-section along the long axis of the frame piece, that is outwardly-open, e.g. is in the general form of a U-shaped channel with the open end of the U facing outward. In some embodiments, the primary frame piece 121 (and thus the section of a primary frame portion that is provided by the primary frame piece) may comprise a main body 32 and an inward wall 33 and an outward fall 34, that are spaced apart from each other so as to define an above-described elongate, upstream-open-ended slot 131. In particular embodiments, inward wall 33 may exhibit a thickness, in the inward-outward direction (as indicated by arrow 132 of FIG. 7) that is relatively small. Thus in various embodiments, the thickness of inward wall 33 may be no more than 500, 300, 200, 150, or 100% of the inward-outward width of elongate slot 131. Inspection of FIG. 10 reveals that minimizing the thickness of inward wall 33 can allow wall 33 to reside within a space between reinforced edge panel 57 and its nearest-neighbor pleat panel 64, without pleat panel 64 being pressed against inward surface 28 of inward wall 33. This can maximize the area of the pleated media 51 that is available to perform filtration.

A primary frame piece 121 may comprise any suitable shape when viewed in cross-section (i.e., when viewed along the long axis of the primary frame piece as in FIG. 7). In some embodiments, a frame piece (whether primary, secondary, or a corner piece) may comprise an outer wall that is closed rather than open as in FIG. 7. That is, a frame piece may exhibit a cross-sectional shape that is generally tubular rather than taking the form of an outwardly-open U-shaped channel. However, such a tubular shape need not necessarily be exactly (or even generally) circular; rather, in various embodiments a frame piece may exhibit a shape that is e.g. a square, a rectangle, a squircle, an oval, an irregular polygon, and so on.

In some embodiments, this shape may be asymmetrical, e.g. to limit the number of orientations in which a male fitting of a corner frame piece can be inserted into an open end of the primary frame piece. Thus in the exemplary design shown in FIG. 7, the outward edges 38 of the frame piece exhibit oppositely-facing J shapes. Further, the upstream wall 35 of the frame piece exhibits an inward region that is slightly sloped. Still further, the downstream wall 36 of the frame piece exhibits a shoulder 37. All of these features combine to define an interior space 39 within the primary frame piece, that has a specific, non-symmetric shape. As evident in FIG. 6, a male fitting 152 of a corner frame piece 150 can be arranged (e.g., shaped and sized) in view of the size and shape of the primary frame piece to limit the number of orientations in which the fitting can fit into the open end of the primary frame piece. Any or all of the various geometrical features described above, may be used as desired.

A secondary frame piece 122 may be similarly designed. The exemplary secondary frame piece 122 shown in FIG. 8 has a main body 41 comprising an inward wall 42 from which protrudes a previously-described downstream support flange 43. The outward edges 44 of the secondary frame piece exhibit oppositely-facing J-shapes. These items collectively define an interior space 45. As evident from FIG. 6, a male fitting 154 of a corner frame piece 150 can be shaped and sized to fit within this interior space. As evident from the exemplary designs presented in the Figures, the shape of interior space 45 of secondary frame piece 122 can differ from the shape of interior space 39 of primary frame piece 121, to minimize the likelihood of incorrectly mating a corner frame piece fitting to a primary frame piece rather than to a secondary frame piece, or vice versa. It is noted in passing that in many embodiments, a primary frame piece 121 will not comprise a downstream support flange akin to downstream support flange 43 of a secondary frame piece 122. That is, such a downstream support flange may be beneficial along the secondary, corrugated edges of the pleated filter media, but may not be needed along the primary, non-corrugated edges of the pleated filter media.

In many embodiments, an air-filtration area 24 that is defined by perimeter frame 20, will be defined on two opposing (primary) edges by an inward surface 28 of an inward wall 33 of a primary frame portion 21, and will be defined on two other opposing (secondary) edges by an inward terminus 25 of a downstream support flange 43 of a secondary frame portion 22.

The various pieces that can be assembled to form a perimeter frame 20 may be made of any suitable material(s) and may be made by any suitable process. In some embodiments, all such pieces may be made by injection molding, thermoforming, or similar methods. However, in some embodiments, primary frame pieces 121 and/or secondary frame pieces 122, e.g. if they are uniform along their elongate length as made, may be made by profile extrusion. Such a method may be at least quasi-continuous and thus may allow advantageously higher output. That is, these frame pieces may be extruded continuously and then cut to any desired length. In contrast, items such a corner frame pieces that are not uniform in this manner, may be made e.g. by injection molding. It will now be evident why, in at least some embodiments, it may be advantageous to provide the corner frame pieces with male fittings that are sized and shaped to fit into open ends of primary or secondary frame pieces that are uniform along their elongate extent. That is, such fittings can be easily molded as integral sections of the corner frame pieces and do not require any modification of the open ends of the primary or secondary frame pieces in order to mate therewith.

In some embodiments, a reinforced edge panel 57 of a primary edge of a pleated filter media 51 may comprise at least one mating feature somewhere along the elongate length of the reinforced edge panel. If so, at least one complementary mating feature may be provided somewhere along the elongate length of the elongate slot 31 into which the reinforced edge panel is to fit. The mating feature and/or the complementary mating feature may be configured so that if the reinforced edge panel does not comprise a mating feature in the proper location and/or of the proper shape, size, and so on, the presence of the complementary mating feature in the elongate slot will cause the reinforced edge panel to not fit properly into the elongate slot of the primary frame portion. Such arrangements can ensure that only such pleated filter media that is specifically configured for use in a particular perimeter frame, can be successfully installed in that perimeter frame.

Exemplary mating features 63 are visible in the reinforced edge panels 57 of pleated filter media 51 as shown in FIG. 11. The depicted mating features 63 are notches that are open at the downstream terminal edges of the edge panels. In such a case, a complementary mating feature may be provided within an elongate slot of a primary frame portion, in the shape of an abutment that is sized and shaped to fit within notch 63 when the reinforced edge panel is inserted into the elongate slot. If the notch 63 is not present in the edge panel, the complementary mating feature will physically prevent the edge panel from sufficiently entering the elongate slot.

In some embodiments, a mating feature and a complementary mating feature may be respectively present in an edge panel 57 and an elongate slot 31 in order to perform a different function; for example, to help secure the reinforced edge panel in the elongate notch. In many embodiments this may not be necessary; that is, the reinforced edge panels may reside securely in the elongate slots without any additional measures being taken. However, in some embodiments, such measures may be taken if desired. Thus for example, in the depicted illustration of FIG. 11, each reinforced edge panel 57 comprises an additional mating feature in the form of an orifice 65. In such a case, an elongate slot 31 may comprise a protrusion (which will be referred to in general as a post) that is sized and shaped to reside within orifice 65 when the edge panel is properly seated within the elongate slot. In such a case, it may be necessary to provide that the orifice and post can slide over each other as the edge panel is inserted into the elongate slot, so that the post can become seated in the orifice. This may be achieved in any number of ways. For example, the post may have a sloped surface (e.g. so that the post is in the form of a ramp) that allows the edge of the orifice to travel along the sloped surface until the post is seated in the orifice. Such an arrangement may be aided by the fact that materials that are used to form a reinforced edge panel, e.g. paperboard, may be slightly compressible. In another approach, the inward wall 33 that (in combination with outward wall 34) defines the elongate slot 31 may be at least slightly deflectable inward. In such a case, the section of the inward wall that is closest to the post may be momentarily deflected inward (e.g. by the fingers of the end-user) as the edge panel is inserted into the elongate ramp, to allow the orifice to slide over the post. It will be appreciated that other arrangements are possible. In many such embodiments, the mating feature(s) of an edge panel 57 may be “negative” features (e.g. a notch, an orifice, etc.) that are obtained by removing material from the edge panel by subtractive methods (e.g., by laser cutting, die cutting, etc.). In such cases, the complementary mating features of a slot 31 may be “positive” features (e.g., a protrusion, post, boss, etc.) that are obtained by additive methods (e.g. by 3D printing). However, in some embodiments these may be reversed.

When it is desired to remove a pleated filter media from a frame (e.g. in the event that the filter media is judged to be approaching the end of its useful life), the reinforced edge panels of the pleated filter media can be removed from the elongate slots of the frame. In some embodiments, removal tabs 66 of the general type described earlier herein may facilitate this. If necessary, an inward wall may be momentary deflected outward e.g. if it is necessary to unseat a post of the elongate slot from an orifice of the reinforced edge panel. In some embodiments, a reinforced edge panel may comprise a line of weakness (imparted e.g. by perforation) that originates at an orifice in the reinforced edge panel, with the line of weakness being oriented so that the application of a sufficient force in the upstream direction (e.g. by way of an end-user pulling on the reinforced edge panel) can cause the reinforced edge panel to separate (tear) along the line of weakness. This can allow the edge panel to exit the slot without being prevented from doing so by the presence of a post in the slot. Such a line (or zone) of weakness may be configured so that it will not be triggered merely by the force of air impinging on the filter media, but will be triggered by the application of sufficient force when an end-user pulls to remove the reinforced edge panel from the elongate slot.

Strictly speaking, any complementary mating feature that is present in an elongate slot 31 of a primary frame portion will be a feature of (e.g. will integrally protrude from) an inward wall 33 and/or an outward wall 34 that define the elongate slot 31. Such a feature may thus take the form of a protrusion, post, boss, projection, or the like, that protrudes inwardly from outward wall 34, or a like feature that protrudes outwardly from inward wall 33, or features of both walls used in combination. While any such feature may be positioned at any location along a primary frame portion, it will be appreciated that it can be advantageous to position such features in a particular manner.

That is, ordinary artisans will appreciate that to include a complementary mating feature (e.g. a boss, protrusion, etc.) in a primary frame piece that is profile-extruded, will likely require some type of post-processing of the primary frame piece. That is, any such feature will likely have to be inserted by additive manufacturing (e.g. by 3D printing) or be obtained by a subtractive method such as laser-cutting. Such post-processing may significantly reduce the advantages of making the primary frame pieces by a quasi-continuous method such as profile extrusion.

Thus, in some embodiments, any such complementary mating feature may be advantageously located in an elongate slot 151 of a corner frame piece 150, e.g. in a location 29 as indicated in generic representation in FIG. 6. It will be straightforward to provide such a mating feature in a corner frame piece that is made e.g. by injection molding. Thus in the exemplary illustration of FIG. 11, the above-described mating features 63 and 65 are provided in minor sections 59 of reinforced edge panels 57 that will reside in elongate slots 151 of corner frame pieces 150 rather than features 63 and/or 65 being in a more central, major section 58 of edge panel 57 that will reside in an elongate slot 131 of a primary frame piece 121.

It is emphasized that various arrangements disclosed above may only be needed in the particular instance that a perimeter frame is user-assembled from a kit of multiple component pieces. Many variations are possible, e.g. in the event that the perimeter frame is e.g. a two-part or clamshell frame rather than a kit-derived frame that is assembled from multiple (e.g., three, four or more) pieces. For example, in some variations, a securing feature may be present that does not necessarily also serve as a complementary mating feature.

In various embodiments, primary and secondary frame pieces, and corner frame pieces, may be made of any suitable material, chosen e.g. from commonly injection-moldable or profile-extrudable materials such as e.g. polypropylene, nylon, ABS, and so on. In some embodiments (particularly e.g. if the corner frame pieces are injection-molded and the primary and secondary frame pieces are profile-extruded), the corner frame pieces may be made of different materials from the primary and/or secondary frame pieces. For example, the primary and/or secondary frame pieces may be made of at least somewhat more rigid materials, while the corner frame pieces may be made of somewhat less rigid materials, e.g. so that an inward wall of the corner frame pieces may be at least slightly deflectable. In some embodiments, a corner frame piece may take the form of two separately molded sub-pieces that are assembled together, e.g. with one such sub-piece being made of a less rigid material. In some embodiments, a portion of a corner frame piece (e.g. an inward wall) may be overmolded onto the other portions of the corner frame piece, e.g. if the inward wall is desired to be at least somewhat deflectable even with the remainder of the corner frame piece being rather rigid.

In some embodiments, a pleated air filter media 51 e.g. in the form of a pleatpack 50, may be supported by a perimeter frame 20 alone. In other embodiments, at least one downstream support member 201 may be present, as shown in exemplary embodiment in the downstream view of FIG. 2. (The combination of a perimeter frame and at least one downstream support member will be referred to herein as a support structure 15.) As defined herein, a downstream support member 201 is an elongate member that is connected to the perimeter frame 20 and extends across at least a portion of the air-filtration area 24 defined by the perimeter frame. By extends across the air-filtration area is meant that such a member originates and terminates on different frame portions. In some embodiments, such a member or members 201, being present on the downstream side of the pleated air filter media, can help the pleated media resist the force of the air impinging on the upstream side of the pleated air filter. In some embodiments, such a support member may be in the form of a downstream support subassembly 200 that includes multiple support members 201, as in the exemplary design of FIG. 2. In some embodiments any such support member 201 or support subassembly 200 may be provided to an end-user as part of a kit that includes the previously-described frame pieces. In some such embodiments the support member or subassembly, as packaged in such a kit, is not connected to any primary or secondary frame piece or to any corner frame piece. An end-user will thus attach the support member or subassembly to the perimeter frame after (or during) assembly of the perimeter frame.

In the depicted exemplary embodiment of FIG. 2, a downstream support subassembly 200 comprises multiple downstream elongate support members 201 that are pivotally connected to each other at a pivotal connection 202. Terminal ends 204 of elongate support members 201 are connected e.g. to corners 23 of the perimeter frame, for example to corner frame pieces 150 of the frame. Such a support subassembly, when attached to the perimeter frame, may form a general “X” shape. The support subassembly may be packaged in a kit with the support subassembly collapsed, scissor-style, in a configuration in which the elongate members are closely aligned with each other. An end use can then expand the members into the “X” configuration in which they can be attached to the perimeter frame. Any suitable hinged connection may be present at pivotal connection 202. For example, members 201 may each comprise an orifice; the orifices may be aligned and a cap positioned so that a stem of the cap serves as an axle about which the members can be pivotally rotated, as in the exemplary design of FIG. 2.

In some embodiments a downstream support subassembly 200 can support the filter media. For example, under the force of the air that impinges on the filter media from the upstream direction, at least some downstream pleat tips of the filter media may contact the subassembly so that the filter media is supported thereby. However, in some use configurations the filter media may not necessarily contact the subassembly and/or be supported thereby. Rather, in some embodiments the subassembly may primarily serve to stabilize the perimeter support frame. That is, the subassembly may assist in holding the frame in its rectangular shape, may increase the resistance of the support frame to out-of-plane twisting, and so on. (In some embodiments, the subassembly may serve to both stabilize the perimeter frame and to support the filter media.) It will be appreciated that having the elongate support members of the subassembly extend to, and attach to, the corners of the perimeter frame may advantageously facilitate such arrangements. In some embodiments, an upstream support subassembly may be present, in addition to, or as an alternative to, a downstream support subassembly. Any such upstream support subassembly may be configured in the general manner described above for a downstream support subassembly.

In some embodiments, when the support subassembly is installed on the perimeter frame, the central pivotal connection 202 of the support subassembly may be positioned in a central section of the air-filtration area 24 defined by the frame. By this is meant that connection 202 is at a location that is spaced from the geometric center of the air-filtration area 24, a distance that is no more than 30% of the distance from the geometric center of air-filtration area 24 to a frame piece that is closest to the connection 202. In some embodiments a central pivotal connection 202 may be located exactly on the geometric center of area 24 (and of the framed air filter as a whole) as in the exemplary design of FIG. 2; however, this does not have to be the case, as discussed below.

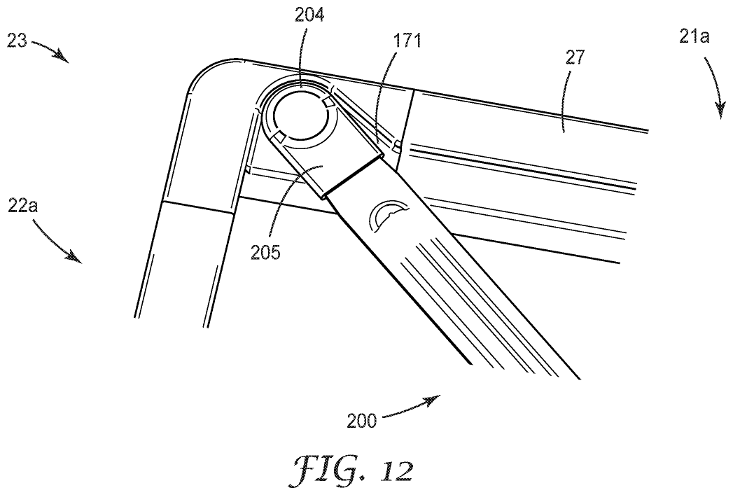

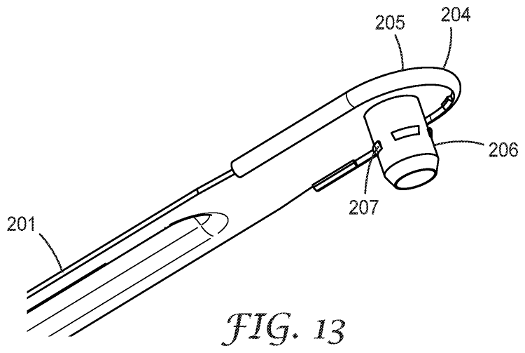

Any such support members 201 may be made of any suitable material (e.g. metal, plastic, and combinations and assemblies thereof), and may be sized and shaped as desired. In many embodiments, the support member(s) may not be attached to the pleated media 51 in any manner (however, the upstream surfaces of the support members may be contacted by the downstream pleat tips of the pleated media as the members provide downstream support to the pleated media). The terminal ends 204 of a support member may be attached (e.g. by an end-user) to a perimeter frame in any suitable manner. In the exemplary arrangement depicted in FIGS. 12 and 13, the terminal end 204 of a member 201 may have a molded plastic cap 205 fitted onto it (e.g., at the factory). Cap 205 may be held in place in any suitable manner, e.g. it may be friction-fitted, held by adhesive, etc. Cap 205 may comprise a post 206 as seen in FIG. 13; in some embodiments this post 206 may pass through an orifice in the terminal end of member 201 to enhance the security with which cap 205 remains in place on the terminal end 204 of the member.

A frame corner 23 (as provided e.g. by a corner frame piece 150) may comprise an orifice 173 (identified in FIG. 4) that is configured to receive post 206 of member 201. An end-user may thus press-fit post 206 into orifice 173 to attach the terminal end 204 of the support member to the frame corner. In some embodiments, such a post 206 may comprise a radially-outwardly-flared waist 207 such that after the flared waist 207 passes through orifice 173, the flared waist will minimize the chances of post 206 becoming dislodged from orifice 173. The flared waist may be sloped (e.g. may be in the form of a ramp) so that the flared waist can easily pass through orifice 173 in the desired direction, but is unlikely to pass through the orifice in the opposite direction. To enhance such arrangements, a post 206 may be made of a material that is slightly compressible (e.g. a resilient, rubbery material); also, the interior of post 206 may be hollow in the general manner evident in FIG. 13. Such arrangements can allow post 206 to be momentarily slightly radially compressed as needed to allow the flared waist 207 to pass through orifice 173, after which the post can re-expand so as to remain seated in orifice 173. The concept of a flared waist encompasses any suitable design. In particular, such a flared waist does not necessarily have to extend continuously around the circumference of post 206. Rather, as in the design shown in FIG. 13, a flared waist may be discontinuous, e.g. it may take the form of a series of protrusions, barbs, or the like, that are spaced circumferentially around the waist.

Inspection of FIG. 4 reveals other useful features, in the form of a cavities 174 that are provided within the interiors of corner frame pieces 150. Such a cavity can provide a space in which the distal (upstream) end of a post 206 can reside. Also, such a cavity 174 can have an outward-facing opening (two such openings are provided in the exemplary corner pieces 150 shown in the Figures herein); such an opening can receive a finger of an end-user so that the end-user can easily grasp the frame to remove the framed filter from a receptacle of a powered air-handling apparatus.

Still another useful feature is evident in FIG. 12, in the form of valley 171 that is provided in the downstream face of corner pieces 150. Valley 171 is configured to accommodate the terminal end 204 of a support member 201 therein, as seen in FIG. 12. This can provide that at least the terminal end 204 of the support member can be positioned at least generally coplanar with the downstream face 27 of perimeter frame 20. In this context, “at least generally coplanar” allows the terminal end of the support member to be positioned even with, or slightly upstream of, the downstream face 27 of the perimeter frame 20. Such arrangements can ensure that the terminal end of the support member does not protrude downstream past the downstream face 27 of the perimeter frame. This can provide that when the framed air filter is inserted into a filter-receptacle of a powered air-handling apparatus, the downstream face 27 of the frame can be in firm contact with e.g. a flange of the filter-receptacle over much or all of the downstream face of the frame. As evident from FIG. 12, such a valley 171 need not be extremely deep or steeply-sloped for such purposes; rather, it may be relatively wide and flat while still being able to sufficiently accommodate the terminal end 204 of the support member.

Powered air-handling systems such as room air purifiers, residential and commercial HVAC systems, and so on, are in use that rely on framed air filters of an extremely wide variety of sizes and shapes (aspect ratios). Thus, a variety of frames of various sizes and shapes may need to be provided to end-users. (In this context, an end-user could be e.g. a homeowner, a renter, a building maintenance engineer, an HVAC technician, and so on.) If any such frame is accompanied by a support subassembly, it would be highly advantageous if the support subassembly did not have to be custom-made for the particular frame. Likewise, it would be advantageous if it were not necessary to custom-make corner frame pieces for every individual frame size and shape in order for a support member to be attachable to the corners of those frames. It is apparent that a support subassembly 200 comprising at least one central pivotal connection 202 of the general type depicted in FIG. 2, will be at least somewhat adjustable. However, additional measures can be employed that further enhance the compatibility between support assemblies and frames so that custom support assemblies and/or custom corner frame pieces do not have to be produced for every single size and shape of filter frame.

For example, a corner frame piece (or, more generally, a location at which a terminal end of a support member is to be connected to the frame) can be provided with the ability to accept support members that approach the connection point at a variety of angles. It will be appreciated that the above-described arrangement in which a terminal end 204 of a support member 201 can be attached to a corner frame piece by way of a mating post and orifice, can provide that terminal end 204 is pivotally connected to the corner frame piece. Thus, the support member can be attached to the corner frame piece in a variety of angular orientations.

An above-described valley 171 that is provided in the downstream side of a corner frame piece 150, can be dimensioned and shaped to enhance this ability. In other words, rather than the sides of valley 171 closely hugging the edges of support member 201, the sides of valley 171 can be spaced away from the edges of support member 201 (as evident from FIG. 12). This allows support member 201 to be oriented over a fairly wide angular range while still remaining connected to the corner frame piece. This functionality allowed by the presence of a suitably designed valley 171 will be referred to herein as providing an “approach angle” range over which a support member can approach the corner frame piece and still be able to fit into the valley so as to be attached to the corner frame piece. In various embodiments, such an approach angle range may be at least 10, 20, 30, 40, or 50 degrees. In further embodiments, such an approach angle range may be no more than 90 or 70 degrees. (In the exemplary embodiment of FIG. 12, such an approach angle range appears to be at least approximately 60 degrees.)

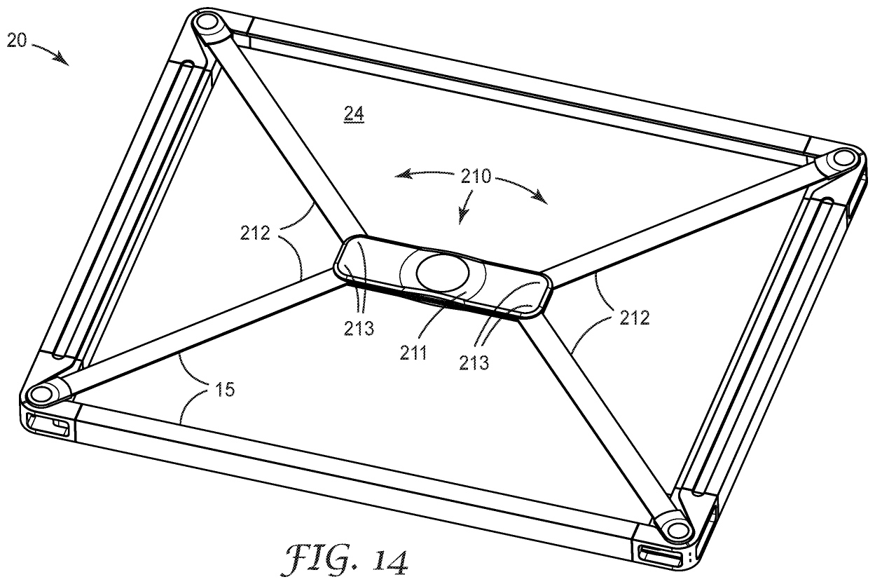

Still other variations are possible in order to further enhance the ability of a few designs (or even a single design) of support assemblies to be used in combination with perimeter frames of a variety of shapes and sizes. One such exemplary design is shown in FIG. 14. In this “double-wishbone” design, support subassembly 210 comprises a central strut 211, first and second elongate support members 212 that are pivotally connected to a first end of central strut 211 by first and second pivotal connections 213, and third and fourth elongate support members 212 that are similarly pivotally connected by third and fourth pivotal connections 213 to a second, opposing end of the central strut. (In this design, the four pivotal connections 213 are still at least generally centrally located within air-filtration area 24 in the manner described earlier herein.) The presence of such multiple, independently pivotable elongate members can allow support subassembly 210 to be manipulated so that the terminal ends of the elongate members are attachable to corners of frames of a variety of shapes and sizes. Also, a support subassembly of this “double-wishbone” design may be able to be folded to a smaller size (in particular, to a smaller length) in comparison to the “X” design depicted in FIG. 2, e.g. so as to reduce the overall size of a kit that comprises the support subassembly.

If further adjustability is desired, central strut 211 may be configured to have an adjustable length, e.g. by forming strut 211 of two pieces that are slidably extendable and contractable relative to each other, telescope-style. It is further noted that an elongate support member does not necessarily need to be connected to the exact corner of a perimeter frame. Thus, in some embodiments, an attachment point (e.g. as dictated by an orifice 173), as provided by a corner frame piece, may be offset at least somewhat from the “exact” corner of the piece. This may further allow a limited number of support subassemblies to be attached to frames of a wide variety of sizes and shapes.

Regardless of the particular arrangement, a perimeter frame (and a support structure comprising any such perimeter frame along with a support subassembly) as disclosed herein is specifically configured so as to not be adjustable in size or shape. That is, a kit as disclosed herein will be configured to form a perimeter frame (or support structure) that, once assembled into its designated size and shape, is not adjustable. The presently-disclosed perimeter frames and framed air filters that rely on such frames, are thus distinguished from e.g. framed air filters that are adjustable to fit a variety of receptables of various shapes, sizes, etc.

As noted, in some embodiments an end-user may be provided with a kit that includes primary and secondary frame pieces, corner frame pieces, a support subassembly, and one or more pleated filter media. The pleated filter media may be in a collapsed condition; if present, a support subassembly may be collapsed or compacted at least to some degree. The end-user can assemble the various frame pieces in the manner disclosed herein, and can attach the support subassembly if present, to form a perimeter frame.

In some embodiments, once the various frame pieces are assembled together, one or more ancillary attachment methods may be used to assist in holding some or all of the frame pieces together. In some embodiments such attachment may be permanent, e.g. if it is envisioned that there will be no need to ever disassemble the frame. Any such (permanent or non-permanent) attachment method may involve e.g. the use of bonding adhesive, mechanical fasteners (e.g. clips, pins, latches, etc.) and so on. However, in some embodiments all of the frame pieces may be fitted together (e.g. friction-fitted) in the absence of any such ancillary attachment method. The use of a support subassembly as described in detail later herein may assist in holding a perimeter frame together in its assembled form in the absence of any such ancillary attachment method.

With the perimeter frame having been assembled, the pleated filter media may then be expanded to its end-use condition and installed into the perimeter frame. The framed air filter can then be inserted into a suitable receptable of a powered air-handling apparatus. The term powered air-handling apparatus encompasses, among others, room air purifiers and forced-air heating-ventilating-air-conditioning (HVAC) systems. In this context, the term HVAC broadly encompasses systems that perform only heating, systems that perform only cooling, and systems that perform both (of course, such systems can also be operated to recirculate and filter air, even if the system is neither heating or cooling at the time).

At a desired time (e.g. if it is considered that the pleated filter media is approaching the end of its useful life) the framed air filter can be removed from the receptable of the powered air-handling apparatus (noting that the previously-described open-ended cavities 174 provided in the perimeter frame can facilitate this). The reinforced edge panels of the pleated media can then be removed from the elongate slots, thus removing the pleated filter media from the perimeter frame. Reinforced edge panels of a fresh (replacement) pleated filter media can then be inserted into the elongate slots to install the fresh filter media into the frame, after which the framed air filter can be inserted into the powered air-handling apparatus.

A kit of multiple frame pieces, to be assembled e.g. by an end user, may take any form. For example, a starter kit may comprise various frame pieces along at least one collapsed pleated filter media. Only a single collapsed pleated filter media may be present in the kit; or, multiple collapsed pleated filter media may be present. Many variations are possible. For example, a kit may have at least one corner frame piece already attached to a primary or secondary frame piece. Such arrangements are acceptable as long as they do not result in the kit occupying an unacceptably large volume. Since it is envisioned that a perimeter frame, once assembled, can be used repeatedly over a long period of time, replacement pleated filter media may be available that do not include any frame pieces. These may be provided in the form of replacement filter packs that include one, or multiple, collapsed pleated filter media.

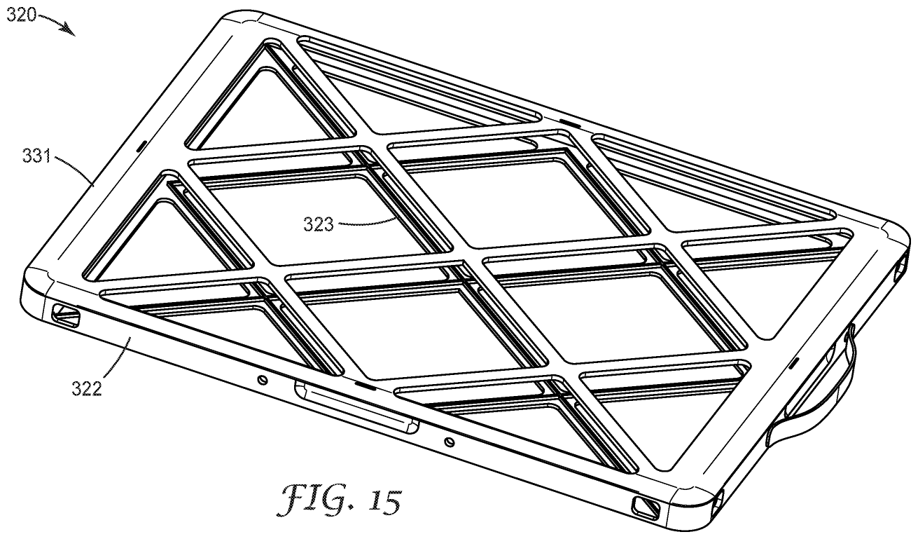

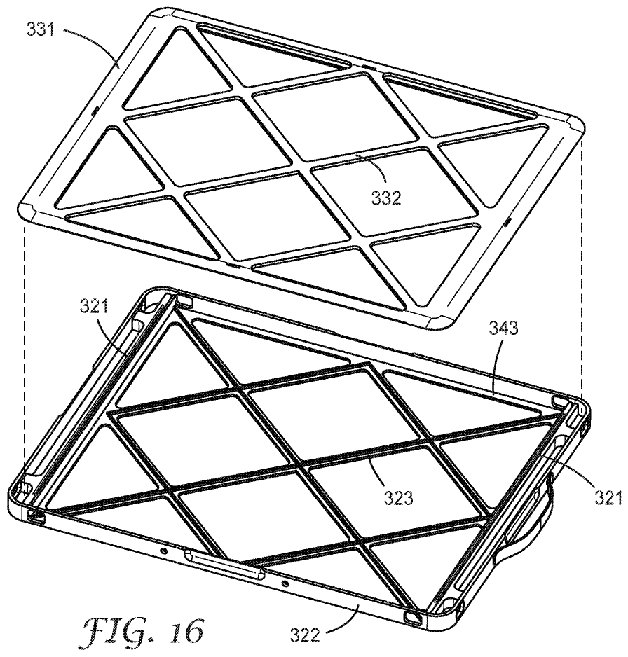

The disclosures herein, particularly those regarding the providing of upstream-open-ended elongate slots configured to receive and hold reinforced edge panels of primary edges of a pleated air filter media in order to install the pleated air filter media in a perimeter frame, are not limited to being used in the particular arrangements disclosed so far herein. Thus for example, in some embodiments a perimeter frame 320 for a pleated air filter may take the general form shown in FIGS. 15 and 16. The depicted arrangement is one in which perimeter frame 320 comprises a main body 322 and a cover 331 that is mateable to main body 322 to provide a space to accommodate a pleated air filter media. In some embodiments, such an arrangement may take the form of a “clamshell” design in which cover 331 is hingedly attached to main body 322 so that cover 331 may be rotated to an open position to allow a pleated air filter media to be inserted into the space. In other embodiments, such an arrangement may be a “two-part” design in which cover 331 is completely separable from main body 322 (such an arrangement is depicted in the exemplary design of FIG. 16). Cover 331 may be held in place on main body 322 by any suitable mechanism or arrangement. Such arrangements may include e.g. one or more latches (e.g. of the general type disclosed in U.S. Pat. No. 6,955,702, which is incorporated by reference in its entirety herein), one or more magnets, and so on.

Any such design (e.g. clamshell or two-part) will typically be produced in the factory and provided to an end-user who can open the frame so as to insert a filter media thereinto. Such designs will be distinguished from previously-described arrangements in which a major component of a frame (e.g. a main body or a cover) is itself formed from the assembly of multiple pieces that are provided to an end user in the form of a kit for assembly by the end user. Whatever the particular design, main body 322 can comprise first and second primary frame portions that comprise first and second upstream-open-ended elongate slots 321 as indicated in FIG. 16. These elongate slots can function in similar manner as described earlier herein. In many embodiments, main body 322 will thus be positioned downstream (so that its elongate slots 321 are upstream-open-ended) with cover 331 being positioned upstream of main body 322. Main body 322 can further comprise first and second secondary frame portions that comprise first and second downstream support flanges 343; such flanges can function in similar manner as described earlier herein.

As noted, perimeter frame 320 differs from the previously-described frames in various aspects. Rather than the end-user receiving a kit comprising various frame pieces (e.g., primary, secondary, and corner frame pieces) to be assembled to form the frame, the main body 322 may be made as a single, e.g. integral piece at the factory, e.g. by injection molding. Cover 331 may be similarly made as a single, e.g. integral, piece (which may be factory-attached to main body 322 if the frame is to be a clamshell design). The end-user thus need not assemble any frame pieces but rather may simply open and/or temporarily detach the cover and insert the pleated filter media. Still further, main body 322 comprises support members 323 that are integral to (e.g. are molded along with) main body 322. Support members 332 of cover 331 are similarly integral to cover 331. Thus, there is no need to attach a support subassembly to perimeter frame 320 in the manner described earlier herein. FIGS. 15 and 16 also indicate that in some embodiments, support members may be present on the upstream side of the filter media, rather than only being present on the downstream side.

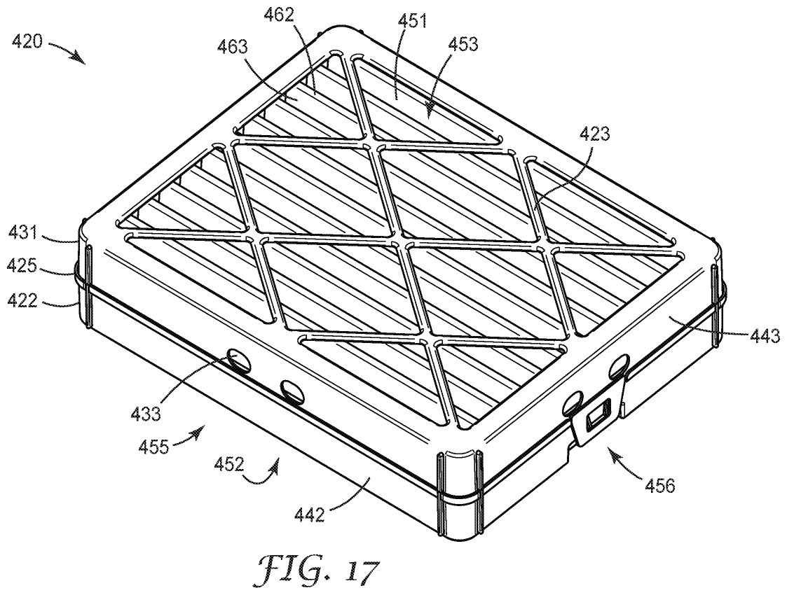

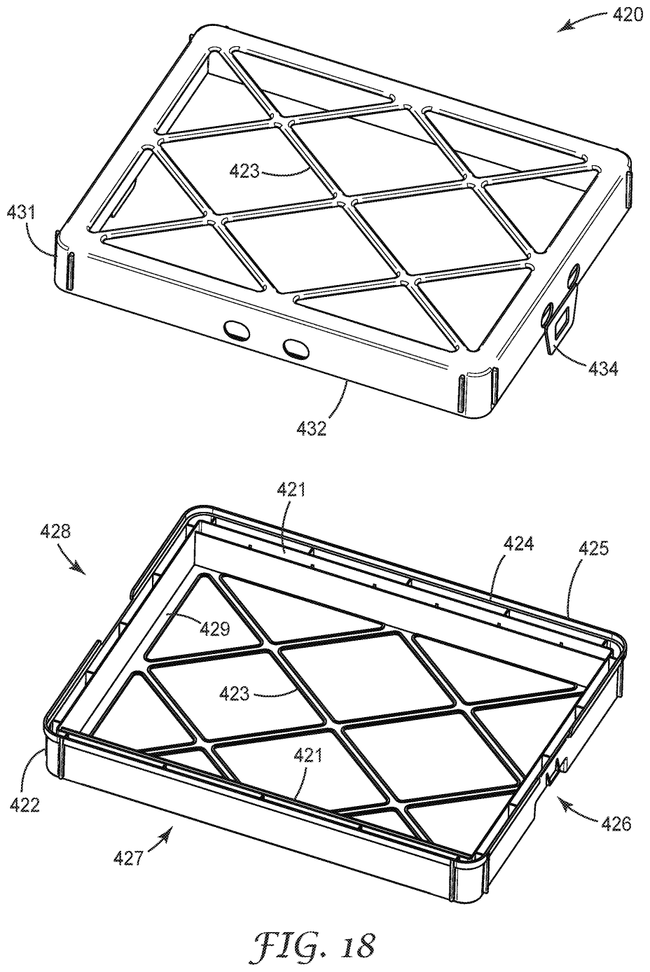

Another arrangement that is encompassed within the disclosures herein is depicted in FIGS. 17-20. The depicted arrangement is one in which perimeter frame 420 comprises a first, downstream piece (body) 422 and a second, upstream piece 431 that is mateable to first piece 422 to provide a space to accommodate a pleated air filter media 451. In the depicted design, first and second pieces 422 and 431 that combine to form frame 420 are approximately co-equal in size, rather than one piece being a main piece and the other being a cover. The depicted arrangement is a two-piece design in which upstream piece 431 is separable from downstream piece 422 (e.g. in order to install a filter media in the frame), as evident from FIG. 18. The pieces, as assembled together, may be held together e.g. by way of latches 426 and 434. In the depicted design, each piece comprises support members 423 (in the form of a lattice) that are integral with the piece.

In the depicted arrangement, opposing ends 428 of first, downstream piece 422 can comprise first and second opposing secondary frame portions of the frame, in the general manner discussed earlier herein. These opposing secondary frame portions (along which the secondary/corrugated edges 456 of the pleated filter media will extend) can each comprise a downstream support flange 429 against which downstream pleat tips of the pleated filter media may be abutted when the filter media is installed in the perimeter frame. Opposing ends 427 of frame piece 422 can comprise first and second opposing primary frame portions of the frame, again in the general manner discussed earlier herein. These opposing primary frame portions (at which the primary/non-corrugated edges 455 of the filter media will be located) do not necessarily need to include any such downstream support flanges, although they can be provided if desired.

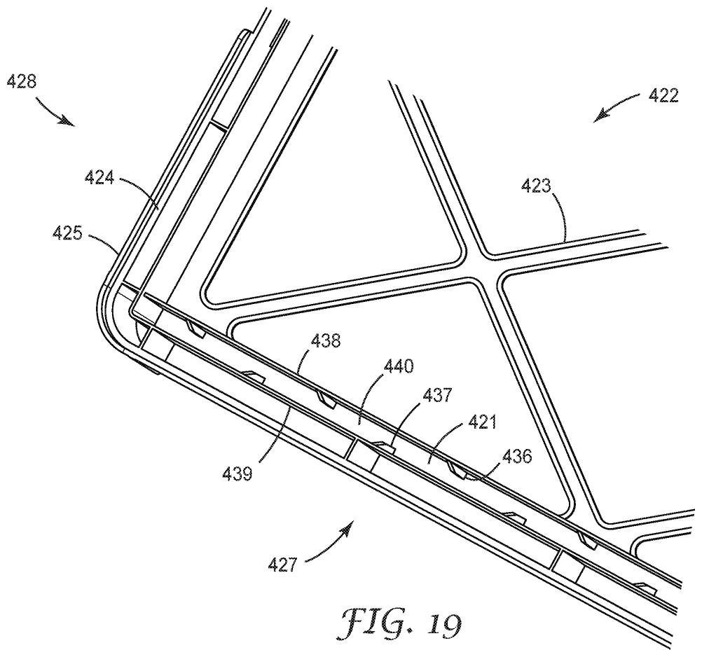

In the depicted design, sidewall 442 of downstream piece 422 comprises an upstream-facing “shoulder” or ledge 424 (most easily seen in FIG. 19) that extends substantially along the entire sidewall 442 of piece 422 and against which a downstream end 432 of upstream piece 431 is abutted when pieces 422 and 431 are assembled together. Sidewall 442 of downstream piece 422 further comprises an upstream-extending skirt 425 that (when pieces 422 and 431 are assembled together) outwardly abuts a lower portion of sidewall 443 of upstream piece 431. Such arrangements can minimize any air leaks through the junction between the upstream and downstream frame pieces 431 and 422. The depicted arrangement further includes orifices 433 which can allow the frame to be grasped and handled (in the depicted design, orifices 433 are in sidewall 443 of upstream piece 431, but may be in sidewall 442 of downstream piece 422).

As evident in FIG. 18 and in particular in the magnified view of FIG. 19, first, downstream piece 422 (e.g., a primary frame portion provided thereby) will comprise an upstream-open-ended elongate slot 421 that is configured to receive and seat a reinforced edge panel 457 of a pleated filter media 451. In the depicted embodiment, slot 421 is defined by inward wall 438 and outward wall 439 which collectively define an upwardly-open-ended space 440 therebetween. In the depicted arrangement, space 440 has an overall width (in a direction aligned with the expansion direction of the pleated filter media) that is noticeably greater than the “thickness” of the reinforced edge panel 457 (described later) of the filter media, and is equipped with securing features in the form of sloped ribs 436 and 437. As evident in FIG. 19, ribs 436 face outward and ribs 437 face inward, and are spaced (along a direction aligned with the pleat direction of the pleated filter media) in an alternating arrangement. Each rib is sloped so that it is easy to insert a leading edge of the reinforced edge panel 457 into slot 421 and so that as the leading edge of edge panel 457 penetrates further downstream into slot 421, the edge panel is held more tightly, so that when the edge panel is fully seated into slot 421, the edge panel (and thus the pleated filter media as a whole) is held securely. In some embodiments, oppositely-facing ribs 436 and 437 may be configured so that the reinforced edge panel is held in slot 421 in a slightly undulating manner (along the long axis of the reinforced edge panel). In the depicted arrangement, ribs 436 and 437 serve as securing features in the manner generally described earlier herein, but do not necessarily serve as complementary mating features.

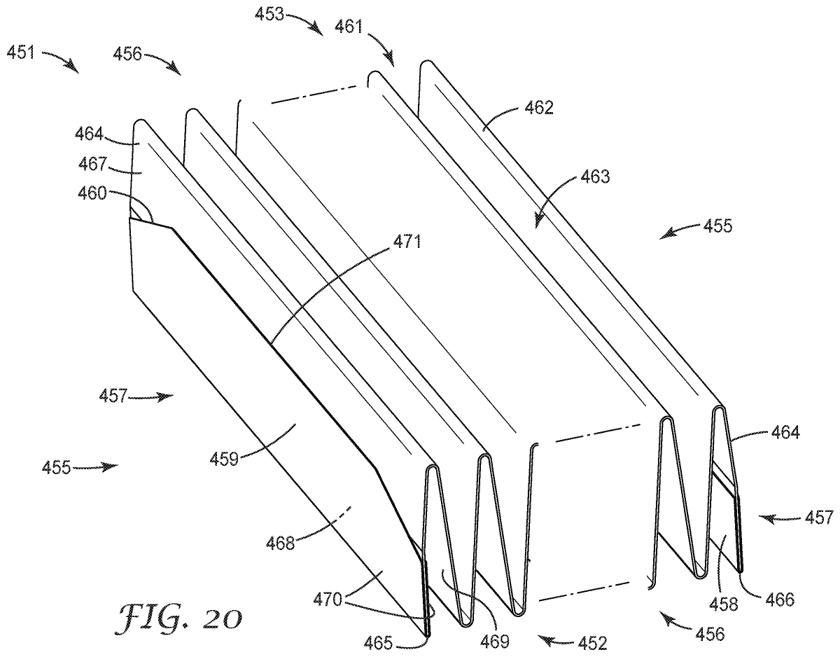

Frame 420 as depicted in FIGS. 17-19 is configured to receive and support pleated filter media. One example of a suitable pleated filter media 451 is shown in FIG. 20 is a partial view that shows primary opposing ends/edges 455 of the filter media and adjacent portions, with the central portion (along the expansion direction) of the media omitted so that features and arrangements of the primary ends can be more easily seen. However, it will be understood that such pleated filter media, when depicted in its entirety, will exhibit an appearance generally similar to pleated filter media as shown e.g. in FIG. 9. Exemplary pleated filter media 451 includes a plurality of pleats 461 and comprises upstream pleat tips 462 and upstream pleat valleys 463, downstream pleat tips and valleys, an upstream face 453 and a downstream face 452, primary ends/edges 455 and secondary, corrugated ends/edges 456, and a pleat direction and an expansion direction, all in the general manner described earlier herein.

When the pleated filter media 451 is installed in frame 420, secondary, corrugated opposing edges 456 of the pleated filter media may be closely abutted against (e.g. in contact with) an inward surface of a inward wall 438 of first, downstream frame piece 422. Also, downstream pleat tips of secondary, corrugated edge sections of the pleated filter media may be closely abutted against (e.g. in contact with) an upstream surface of a downstream support flange 429 of first, downstream frame piece 422, again in the general manner described earlier herein. Although not depicted in FIGS. 17-20, in some embodiments pleated filter media 451 may comprise one or more entities configured to limit the expansion of the pleated media, again in the general manner described earlier herein.

Pleated filter media 451 as depicted in FIG. 20 comprises first and second reinforced edge panels 457 at opposing, primary ends/edges 455 of the pleated filter media. In the depicted embodiment, reinforced edge panels 457 are non-integral reinforced edge panels achieved by respectively attaching (at least) first and second separately-made pieces of material (e.g. chipboard, a suitably stiff nonwoven, etc.) to the first and second primary ends 455 of the pleated filter media. Reinforced edge panels 457 function in a generally similar manner as described previously herein (i.e., they are configured to be inserted into respective elongate slots 421 at opposing ends of downstream frame piece 422); however, they have significant features and arrangements that differ from those described previously herein.

Reinforced edge panels 457 as shown in FIG. 20 can be achieved by taking a separately-made piece of reinforcing material (e.g. chipboard) 470 and attaching it to at least one end pleat-panel 464 of the pleated filter media 461. In the depicted embodiment, this is done in a “wrap-around” manner. Specifically, an inward portion 458 of reinforcing piece 470 can be abutted against an inward face of end pleat-panel 464, with piece 470 then being wrapped around the downstream side of end pleat-panel 464 so that an outward portion 459 of piece 470 is abutted against an outward face of end pleat-panel 464 as shown in FIG. 20.

Also as shown in FIG. 20, piece 470 may exhibit a fold that is congruent with the downstream tip 465 of end pleat-panel 464 so that piece 470 includes a downstream apex 466 that is located immediately downstream of downstream tip 465 of end pleat-panel 464. Inward and outward portions 458 and 459 of reinforcing piece 470 will thus bracket a portion 468 of end pleat-panel 464 so that portion 468 of pleat-panel 464 is “sandwiched” between portions 458 and 459 of reinforcing piece 470. Inward portion 458 of piece 470 may be attached to the inward face of pleat-panel and/or outward portion 459 of piece 470 may be attached to the outward face of pleat-panel 464. This may be done e.g. via adhesive bonding, bonding via heat and pressure (e.g. ultrasonic bonding), by mechanical bonding (e.g. with staples) and so on. In some embodiments, the attachment may be such that portions 458 and 459 of reinforcing piece 470 are attached to each other (e.g. by using staples that penetrate through the entire multilayer stack of the portions of the reinforcing piece and the portion 468 of end pleat-panel 464 therebetween) with portion 468 of end pleat-panel 464 being captured between the attached portions of the reinforcing piece 470.

Although the exemplary depiction of FIG. 20 shows a single end pleat-panel 464 having a piece of reinforcing material 470 wrapped around it to form a reinforced edge panel 457, in various embodiments, multiple (e.g. two, three, or four) end pleat-panels may be gathered and a piece of reinforcing material wrapped around the gathered stack of end pleat-panels to form a reinforced edge panel 457.

A reinforced edge panel 457 of this type may be inserted into an upstream-open-ended elongate slot of a perimeter frame in the general manner described earlier herein. However, with the presently-described design, the “leading” end of reinforced edge panel 457 (that is, the end that is inserted first into the slot) will be provided by the above-mentioned downstream apex 466 of reinforcing piece 470; the “trailing” end of the reinforced edge panel will be the upstream ends of inward and outward portions 458 and 459 of the reinforcing piece 470. With reinforced edge panel 457 suitably seated into slot 421 in this manner, the outward face of penultimate pleat-panel 469 (that is, the pleat-panel immediately inward of end pleat-panel 464) may abut the inward face of the above-described inward wall 438 of first, downstream frame piece 422. It is noted in passing that the design of reinforced edge panels 457 as shown in FIG. 20 is not limited to use with a perimeter frame of the particular type shown in FIGS. 17-19; rather, such a reinforced edge panel may be used with any perimeter frame (e.g., a frame of the general type depicted in FIGS. 3, 4, and 16 herein) that comprises a suitable upstream-open-ended elongate slot.

It will be appreciated that a “wrap-around” design (e.g., in particular, the attaching of two portions of a reinforcing piece to each other while capturing an end pleat-panel therebetween) can allow a reinforced edge panel to exhibit enhanced mechanical strength and integrity. Other advantages are possible. For example, FIG. 20 depicts an arrangement in which the outward portion 459 of reinforcing piece 470 comprises an upstream-protruding section 460. In some embodiments, this upstream-protruding section 460 may not be bonded to end pleat-panel 464 (or to the inward portion 458 of reinforcing piece 470). Section 460 of reinforcing piece 470 may thus be available to serve as a handle. For example, in order to remove the pleated filter media from the frame, an end user can grasp section 460 (after slightly prising the upstream edge 471 of section 460 outwardly away from the outward face 467 of end pleat-panel 464, if necessary) in order to remove the pleated filter media from the frame. This can allow the end user to handle (e.g. remove) the pleated filter media from the frame without necessarily having to contact the filter media itself. Thus in some such embodiments, there is no need for e.g. a removal tab that is separately made and attached to the pleated media and/or to the reinforced edge panel to facilitate handling of the filter media in the manner described earlier herein.

Further variations are possible. For example, the disclosures herein, particularly those regarding the providing of upstream-open-ended elongate slots configured to receive and hold reinforced edge panels of primary edges of an air filter media in order to install the air filter media in a perimeter frame, are not necessarily limited to being used with air filter media that is pleated. Thus for example, an air filter media may be unpleated (although still equipped with reinforced edge panels at first and second edges of the air filter media). Such a filter media may still be provided to an end user in a compacted or space-saving form, e.g. by way of the filter media being supplied in a rolled-up configuration. The end-user can unroll the filter media and insert the reinforced edge panels into slots in a perimeter frame in the general manner described earlier herein, in order to install the filter media into the perimeter frame.

It will be apparent to those skilled in the art that the specific exemplary embodiments, elements, structures, features, details, arrangements, configurations, etc., that are disclosed herein can be modified and/or combined in numerous ways. In summary, numerous variations and combinations are contemplated as being within the bounds of the conceived invention, not merely those representative designs that were chosen to serve as exemplary illustrations. Thus, the scope of the present invention should not be limited to the specific illustrative structures described herein, but rather extends at least to the structures described by the language of the claims, and the equivalents of those structures. Any of the elements that are positively recited in this specification as alternatives may be explicitly included in the claims or excluded from the claims, in any combination as desired. Any of the elements or combinations of elements that are recited in this specification in open-ended language (e.g., comprise and derivatives thereof), are considered to additionally be recited in closed-ended language (e.g., consist and derivatives thereof) and in partially closed-ended language (e.g., consist essentially, and derivatives thereof). Although various theories and possible mechanisms may have been discussed herein, in no event should such discussions serve to limit the claimable subject matter. To the extent that there is any conflict or discrepancy between this specification as written and the disclosure in any document that is incorporated by reference herein but to which no priority is claimed, this specification as written will control.

What is claimed is:

1. A kit configured to be assembled into a support structure for a rectangular, pleated air filter media, comprising:
first and second opposing primary frame pieces and first and second opposing secondary frame pieces, that are configured to be assembled into a rectangular perimeter frame that supports a perimeter of a rectangular, pleated air filter media, with the rectangular perimeter frame comprising first and second opposing primary frame portions that comprise the first and second opposing primary frame pieces, and first and second opposing secondary frame portions that comprise the first and second opposing secondary frame pieces;
wherein the first and second opposing primary frame pieces respectively comprise first and second upstream-open-ended elongate slots, each upstream-open-ended elongate slot having a long axis that is aligned with a long axis of the primary frame piece and having a depth with a depth axis that is oriented from −10 degrees to +50 degrees relative to an upstream-downstream axis of the primary frame piece, and with each upstream-open-ended elongate slot being configured to, in the assembled rectangular perimeter frame, receive a reinforced edge panel of a primary edge of the rectangular, pleated air filter media,
wherein the first and second opposing secondary frame pieces respectively comprise first and second downstream support flanges, each downstream support flange extending at least generally inward from a main body of the secondary frame piece so that in the assembled rectangular perimeter frame, an inward edge of the downstream support flange defines a secondary edge of an air-filtration area defined by the rectangular perimeter frame.

2. The kit of claim 1 wherein the kit further comprises four corner frame pieces, each corner frame piece being configured to be connected to one primary frame piece and to one secondary frame piece so that the first and second opposing primary frame pieces, the first and second opposing secondary frame pieces, and the four corner frame pieces, are assemblable to form the rectangular perimeter frame, with the first and second opposing primary frame portions of the rectangular perimeter frame comprising the first and second opposing primary frame pieces in combination with a section of at least one corner frame piece, and with the first and second opposing secondary frame portions of the rectangular perimeter frame comprising the first and second opposing secondary frame pieces in combination with a section of at least one corner frame piece.

3. The kit of claim 2 wherein each of the corner frame pieces comprises an upstream-open-ended elongate slot configured so that when the corner frame piece is connected to a primary frame piece, the upstream-open-ended elongate slot of the corner piece becomes a congruent extension of the upstream-open-ended elongate slot of the primary frame piece, so that in the assembled rectangular perimeter frame, the upstream-open-ended elongate slot of the corner frame piece combines with the upstream-open-ended elongate slot of the primary frame piece to collectively form an upstream-open-ended elongate slot of a primary frame portion of the rectangular perimeter frame, with the upstream-open-ended elongate slot of the primary frame piece being configured to receive a major section of the reinforced edge panel of the primary edge of the rectangular, pleated air filter media and with the upstream-open-ended elongate slot of the corner frame piece being configured to receive a minor section of the reinforced edge panel of the primary edge of the rectangular, pleated air filter media.

4. The kit of claim 1 wherein the kit further includes at least one rectangular pleated air filter media, the rectangular pleated air filter media comprising first and second opposing primary edges that are non-corrugated edges and that each comprises a reinforced edge panel that is elongate with a long axis that is aligned with a pleat direction of the rectangular pleated air filter media, the rectangular pleated air filter media further comprising first and second opposing secondary edges that are corrugated edges, the rectangular pleated air filter media being provided in the kit in a collapsed state and being expandable along a direction that is perpendicular to the pleat direction, into an expanded, end-use state.

5. A support structure comprising a rectangular perimeter frame produced from assembling the kit of claim 1.

6. A method of forming a framed air filter from the support structure of claim 5, the method comprising: respectively inserting first and second reinforced edge panels of first and second opposing primary edges of a rectangular pleated air filter media into first and second upstream-open-ended elongate slots of first and second primary frame portions of the rectangular perimeter frame so as to form a framed air filter in which the rectangular pleated air filter media is disposed in an air-filtration area defined by the rectangular perimeter frame and is in an expanded, end-use configuration.

7. A rectangular perimeter frame for an air filter, comprising:
first and second opposing primary frame portions and first and second opposing secondary frame portions,
wherein the first and second opposing primary frame portions respectively comprise first and second upstream-open-ended elongate slots, each upstream-open-ended elongate slot having a long axis that is at least substantially aligned with a long axis of the primary frame portion and having a depth with a depth axis that is oriented from −10 degrees to +50 degrees relative to an upstream-downstream axis of the primary frame portion, and with the first upstream-open-ended elongate slot being configured to receive a first reinforced edge panel of a first primary edge of a rectangular, pleated air filter media, and with the second upstream-open-ended elongate slot being configured to receive a second reinforced edge panel of a second, opposing primary edge of the rectangular, pleated air filter media, and
wherein the first and second secondary frame portions respectively comprise first and second downstream support flanges, each downstream support flange extending at least generally inward from a main body of the secondary frame portion so that an inward edge of the downstream support flange defines a secondary edge of an air-filtration area defined by the rectangular perimeter frame.

8. The rectangular filter frame of claim 7 wherein the rectangular filter frame comprises a main body that comprises the first and second opposing primary frame portions and the first and second opposing secondary frame portions, and wherein the rectangular filter frame further comprises a cover that is mateable to the main body so as so provide a space to accommodate the rectangular, pleated air filter media.

9. The rectangular filter frame of claim 7 wherein the rectangular filter frame is a two-piece frame that comprises a first, downstream piece and a second, upstream piece that are assemblable to each other to form the rectangular filter frame, wherein the first, downstream piece comprises the first and second opposing primary frame portions that respectively comprise the first and second upstream-open-ended elongate slots, and wherein the first, downstream piece comprises the first and second secondary frame portions that respectively comprise the first and second downstream support flanges.

10. The rectangular filter frame of claim 7 wherein each of the first and second upstream-open-ended elongate slots comprises an inward sidewall with sloped ribs extending outwardly therefrom and an outward sidewall with sloped ribs extending outwardly therefrom, with the outwardly-extending sloped ribs and the inwardly-extending sloped ribs being spaced, and alternating, along an elongate length of the elongate slot.

11. A method of forming a framed air filter from the rectangular perimeter frame of claim 7, the method comprising: expanding a rectangular pleated air filter media along an expansion direction from a collapsed condition to an expanded, end-use condition, and then respectively inserting first and second reinforced edge panels of first and second opposing primary edges of the rectangular pleated air filter media into the first and second upstream-open-ended elongate slots of the first and second opposing primary frame portions of the rectangular perimeter frame so as to form a framed air filter in which the rectangular pleated air filter media is disposed in an air-filtration area defined by the rectangular perimeter frame and is in the expanded, end-use configuration.

12. The method of claim 11 wherein each of the first and second reinforced edge panels of the first and second opposing primary edges of the rectangular pleated air filter media is a wrap-around reinforced edge panel comprising a piece of reinforcing material with an inward portion that is attached to an inward face of at least one end pleat-panel of the rectangular pleated air filter media and with an outward portion that is attached to an outward face of the at least one end pleat-panel of the rectangular pleated air filter media and that comprises a downstream apex that is located downstream of a downstream tip of the at least one end pleat-panel of the rectangular pleated air filter media.

13. The method of claim 12 wherein the method is performed by an end-user and wherein the method includes a further step of installing the framed air filter into a powered air-handling apparatus chosen from the group consisting of an HVAC system and a room air purifier.

14. The method of claim 13 wherein the method includes a further step of removing the framed air filter from the powered air-handling apparatus and then removing the first and second reinforced edge panels of the first and second opposing primary edges of the rectangular pleated air filter media from the first and second upstream-open-ended elongate slots of the first and second opposing primary frame portions of the rectangular perimeter frame to remove the rectangular pleated air filter media from the rectangular perimeter frame;
wherein the removing of the first and second reinforced edge panels of the first and second opposing primary edges of the rectangular pleated air filter media from the first and second upstream-open-ended elongate slots of the first and second opposing primary frame portions of the rectangular perimeter frame to remove the rectangular pleated air filter media from the rectangular perimeter frame is performed by grasping an upstream-protruding section of the outward portion of the piece of reinforcing material, the upstream-protruding section of the outward portion of the piece of reinforcing material not being attached to the outward face of the at least one end pleat-panel of the rectangular pleated air filter media, so that the upstream-protruding section of the outward portion of the piece of reinforcing material can be grasped substantially without contacting the at least one end-pleat panel.

15. A framed air filter comprising the rectangular perimeter frame of claim 7 and a rectangular pleated air filter media installed in the rectangular perimeter frame, the rectangular pleated air filter media comprising first and second opposing primary edges that are non-corrugated edges and that respectively comprise first and second reinforced edge panels, each of which is elongate with a long axis that is aligned with a pleat direction of the rectangular pleated air filter media, the rectangular pleated air filter media further comprising first and second opposing secondary edges that are corrugated edges, the rectangular pleated air filter media being in an end-use state that is an expanded state in which the first and second reinforced edge panels of the first and second opposing primary edges of the rectangular pleated air filter media are seated within the first and second upstream-open-ended elongate slots of the first and second opposing primary frame portions of the rectangular perimeter frame, so that the rectangular pleated air filter media is disposed within the air-filtration area defined by the rectangular perimeter frame.

16. The framed air filter of claim 15 wherein at least some downstream pleat tips along the first and second opposing secondary edges of the rectangular pleated air filter media are respectively abutted against upstream surfaces of the first and second downstream support flanges of the first and second opposing secondary frame portions.

17. The framed air filter of claim 15 wherein each of the first and second reinforced edge panels of the first and second opposing primary edges of the rectangular pleated air filter media is a wrap-around reinforced edge panel comprising a piece of reinforcing material with an inward portion that is attached to an inward face of at least one end pleat-panel of the rectangular pleated air filter media and with an outward portion that is attached to an outward face of the at least one end pleat-panel of the rectangular pleated air filter media and that comprises a downstream apex that is located downstream of a downstream tip of the at least one end pleat-panel of the rectangular pleated air filter media.

18. The framed air filter of claim 17 wherein each of the first and second reinforced edge panels comprises an upstream-protruding section of the outward portion of the piece of reinforcing material, the upstream-protruding section of the outward portion of the piece of reinforcing material not being attached to the outward face of the at least one end pleat-panel of the rectangular pleated air filter media and being available for grasping as a handle without contacting the at least one end pleat-panel.

19. A rectangular pleated air filter media that is expandable along an expansion direction from a collapsed condition to an expanded, end-use condition, and that comprises first and second opposing primary edges that are non-corrugated edges and that respectively comprise first and second reinforced edge panels, each of which is elongate with a long axis that is aligned with a pleat direction of the rectangular pleated air filter media, the rectangular pleated air filter media further comprising first and second opposing secondary edges that are corrugated edges;
and, wherein each of the first and second reinforced edge panels is a wrap-around reinforced edge panel comprising a piece of reinforcing material with an inward portion that is attached to an inward face of at least one end pleat-panel of the rectangular pleated air filter media and with an outward portion that is attached to an outward face of the at least one end pleat-panel of the rectangular pleated air filter media and that comprises a downstream apex that is located downstream of a downstream tip of the at least one end pleat-panel of the rectangular pleated air filter media.

20. The rectangular pleated air filter media of claim 19 wherein each of the first and second reinforced edge panels comprises an upstream-protruding section of the outward portion of the piece of reinforcing material, the upstream-protruding section of the outward portion of the piece of reinforcing material not being attached to the outward face of the at least one end pleat-panel of the rectangular pleated air filter media and being available for grasping as a handle substantially without contacting the at least one end pleat-panel.
